(19) United States
(12) Patent Application Publication
(10) Pub. No.: US 2016/0295144 A1
(43) Pub. Date: Oct. 6, 2016

(54) SEMICONDUCTOR DEVICE

(71) Applicant: Renesas Electronics Corporation, Tokyo (JP)

(72) Inventor: Masatoshi KIMURA, Ibaraki (JP)

(73) Assignee: Renesas Electronics Corporation, Tokyo (JP)

(21) Appl. No.: 15/077,981

(22) Filed: Mar. 23, 2016

(30) Foreign Application Priority Data
Mar. 31, 2015 (JP) 2015-071001

(51) Int. Cl. H04N 5/378; H04N 5/225

(52) U.S. Cl. CPC H04N 5/378; H04N 5/2253

(57) ABSTRACT

To improve the performance of a solid-state imaging device which is formed by performing division exposure for exposure-processing the entire chip by a plurality of times of exposures and in which pixels arranged in a pixel array area in plural respectively have a plurality of photodiodes. Control signal wirings are coupled to respective photodiodes included in pixels in a first area being a first exposure area for division exposure. Control signal wirings and are coupled to respective photodiodes included in pixels in a second area being a second exposure area.

### CROSS-REFERENCE TO RELATED APPLICATIONS

The disclosure of Japanese Patent Application No. 2015-071001 filed on Mar. 31, 2015 including the specification, drawings and abstract is incorporated herein by reference in its entirety.

### BACKGROUND

The present invention relates to a semiconductor device, and particularly to a technology effective when applied to a semiconductor device including a solid-state imaging device.

When an imaging device (image element) used in a digital camera is formed in a large chip size to deal with high image quality, the entire chip cannot be exposure-processed by one exposure in a manufacturing process of the imaging device and hence a plurality of times of division exposure processes are performed.

Further, it has been known that in a solid-state imaging device to which an image plane phase difference technique used in a digital camera equipped with an automatic focusing system function is applied, each of a plurality of pixels which configure the imaging device is provided with two or more photodiodes.

It has been described in Patent Document 1 (Japanese Unexamined Patent Publication Laid-Open No. 2002-333570) that in an imaging device having two photodiodes in one pixel, the two photodiodes are respectively controlled independently.

### RELATED ART DOCUMENT

### Patent Document

### [Patent Document 1] Japanese Unexamined Patent Publication Laid-Open No. 2002-333570

### SUMMARY

When a solid-state imaging device having a plurality of pixels is irradiated with light to perform imaging, the illuminance of light applied to each pixel far from the optical axis of the light is smaller than the illuminance of light applied to each pixel in the vicinity of the optical axis. This leads to degradation in image quality of an image obtained by imaging, and a reduction in automatic focusing speed.

Further, in a solid-state imaging device formed by division exposure, there is a possibility that a difference will occur in output characteristics between pixels formed by different masks. This also leads to degradation in image quality of an image obtained by imaging, and a reduction in automatic focusing speed.

Other objects and novel features will be apparent from the description of the present specification and the accompanying drawings.

A summary of a representative one of embodiments disclosed in the present application will be explained in brief as follows:

A semiconductor device according to one aspect of the present invention is intended to, in a solid-state imaging device having a plurality of pixels arranged in a matrix form, control each pixel in a first area and each pixel in a second area independently respectively and control two photodiodes in each pixel independently respectively.

According to one aspect disclosed in the present application, it is possible to improve the performance of a semiconductor device.

### BRIEF DESCRIPTION OF THE DRAWINGS

FIG. 1 is a plan layout showing a semiconductor device according to an embodiment 1 of the present invention;

FIG. 2 is a plan layout showing the semiconductor device according to the embodiment 1 of the present invention;

FIG. 3 is a sectional diagram taken along line A-A of FIG. 2;

FIG. 4 is a sectional diagram showing the semiconductor device according to the embodiment 1 of the present invention;

FIG. 5 is an equivalent circuit diagram showing the semiconductor device according to the embodiment 1 of the present invention;

FIG. 6 is a plan layout showing the semiconductor device according to the embodiment 1 of the present invention;

FIG. 7 is a plan layout showing a semiconductor device according to a modification 1 of the embodiment 1 of the present invention;

FIG. 8 is a plan layout showing a semiconductor device according to a modification 2 of the embodiment 1 of the present invention;

FIG. 9 is a plan layout showing a semiconductor device according to an embodiment 2 of the present invention;

FIG. 10 is a plan layout showing the semiconductor device according to the embodiment 2 of the present invention;

FIG. 11 is a plan layout showing a semiconductor device according to a modification 1 of the embodiment 2 of the present invention;

FIG. 12 is a plan layout showing a semiconductor device according to a modification 2 of the embodiment 2 of the present invention;

FIG. 13 is a plan layout showing the semiconductor device according to the modification 2 of the embodiment 2 of the present invention;

FIG. 14 is a sectional diagram taken along line B-B of FIG. 13;

FIG. 15 is a plan layout showing a semiconductor device according to an embodiment 3 of the present invention; and

FIG. 16 is a plan layout showing a semiconductor device according to a modification of the embodiment 3 of the present invention; and

FIG. 17 is a plan layout showing a semiconductor device according to a comparative example.

### DETAILED DESCRIPTION

Embodiments of the present invention will hereinafter be described in detail with reference to the accompanying drawings. Incidentally, in all of the drawings for explaining the embodiments, the same reference numerals are respectively attached to members having the same function, and their repetitive description will be omitted. Also, in the following embodiments, the description of the same or similar parts will not be repeated in principle unless particularly required. Further, a mask mentioned in the present application means a photomask (reticle) used upon exposure in a photolithography process except for a hardmask and a photoresist film or the like used as a protective film for etching or ion implantation.

### Embodiment 1

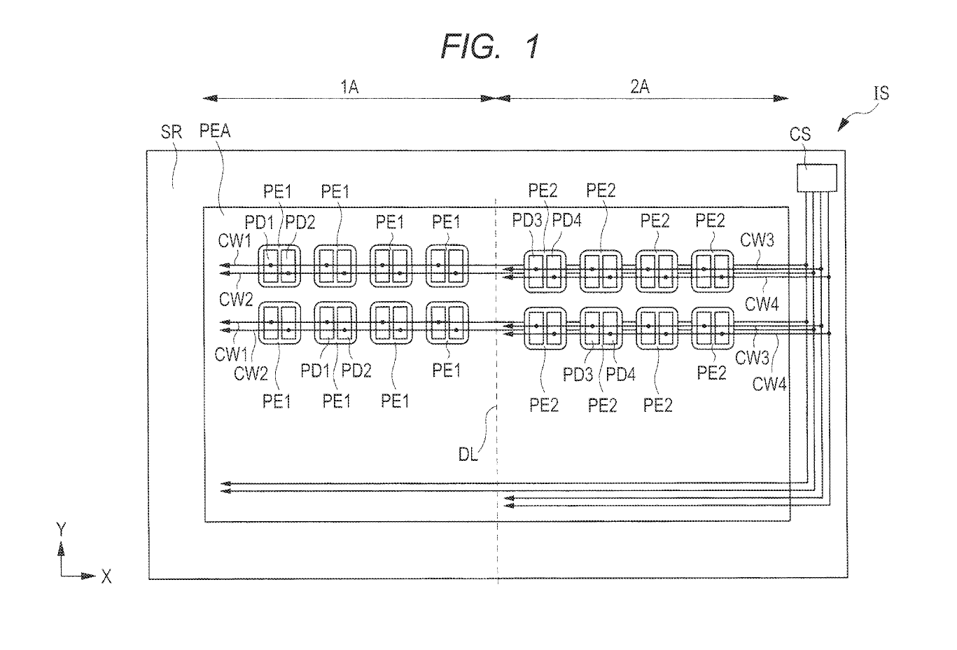

A semiconductor device according to the present embodiment will be described below using FIGS. 1 to 5. The semiconductor device according to the present embodiment relates to a solid-state imaging device and particularly to a solid-state imaging device formed by division exposure and having a plurality of photodiodes within one pixel.

FIG. 1 is a plan layout showing the solid-state imaging device according to the present embodiment. The solid-state imaging device IS that is the semiconductor device according to the present embodiment is a CMOS (Complementary Metal Oxide Semiconductor) image sensor and has, as shown in FIG. 1, a pixel array area PEA and a peripheral area SR which surrounds the pixel array area PEA in plan view. A control signal generating circuit (control signal generating unit, control signal generating means) CS which sends a control signal to each pixel is provided in the peripheral area SR. That is, the peripheral area SR is the end of the solid-state imaging device IS.

Also, although not shown in the drawing, a read-out circuit, an output circuit and a row selection circuit, etc. are provided in the peripheral area SR. Further, although not shown in the drawing, a control circuit which generally manages the whole operation of the present solid-state imaging device is also formed in the peripheral area SR.

These circuits including the control signal generating circuit CS are arranged at the corners of the solid-state imaging device IS, i.e., the corners of the peripheral area SR having an annular rectangular shape in plan view. For example, pads (not shown) or the like for performing electrical coupling to the outside are formed in regions other than the corners in the peripheral area SR, i.e., extending parts along the four respective sides of the peripheral area SR having the annular rectangular shape.

The pixel array area PEA has a rectangular shape in plan view. A plurality of pixels PE1 and PE2 are respectively arranged in the pixel array area PEA in a matrix form. An X-axis direction shown in FIG. 1 is a direction extending along a main surface of a semiconductor substrate which configures the solid-state imaging device, and is a direction extending along a row direction in which the pixels PE1 and PE2 are linearly arranged in a plural form. Further, a Y-axis direction which is a direction extending along the main surface of the semiconductor substrate and is orthogonal to the X-axis direction, is a direction extending along a column direction in which the pixels PE1 or PE2 are linearly arranged in a plural form. That is, the pixels PE1 and PE2 are arranged side by side in a matrix form. Incidentally, in order to make it easy to understand the drawing, only pixels of 8 columns arranged in the X-axis direction and 2 rows arranged in the Y-axis direction are shown, but a greater number of pixels are actually arranged in the X-axis and Y-axis directions.

Here, the pixels PE1 are arranged side by side in plural in a matrix form (array form) in a first area 1A of the pixel array area PEA. The pixels PE2 are arranged side by side in plural in a matrix form (array form) in a second area 2A adjacent to the first area 1A, of the pixel array area PEA. The control signal generating circuit CS is formed at the corner of the peripheral area SR adjacent to the pixels PE2. The first area 1A and the second area 2A are adjacent to each other with a boundary line DL interposed therebetween. The boundary line DL is a line which extends along the Y-axis direction. In the drawing, the boundary line DL is indicated by a broken line.

The solid-state imaging device according to the present embodiment is a semiconductor chip formed by division exposure. That is, a range that can be exposed with one mask is limited in a manufacturing process of a semiconductor device large in chip's area like the solid-state imaging device. There is therefore a case where it is not possible to expose the whole area taken to be one chip in a semiconductor wafer by one exposure using one mask, i.e., one shot.

In this case, for example, exposure is performed twice using two masks to thereby expose the whole area taken to be one chip. In exposure processing by such division exposure, i.e., bond exposure, for example, a first exposure area of the area taken to be one chip is exposed by a first shot, and a second exposure area thereof is exposed by a second shot. Thus, the photoresist film over the semiconductor substrate is exposed twice and thereafter developed to thereby form a prescribed resist pattern, whereby the manufacture of the semiconductor device is done.

The first area 1A shown in FIG. 1 is part of the first exposure area, and the second area 2A is part of the second exposure area. In the figure, elements and wirings, etc. formed in the pixel array area PEA and the peripheral area SR on the left side as viewed from the boundary line DL are formed by a mask for the first exposure area. Elements and wirings, etc. formed in the pixel array area PEA and the peripheral area SR on the right side as viewed from the boundary line DL are formed by a mask for the second exposure area.

It is considered that since the first area 1A and the second area 2A are exposed with the different masks in the division exposure, a group (one group) of the pixels PE2 arranged in matrix is formed at a position deviated in one direction with respect to a group (one group) of the pixels PE1 arranged in matrix. This is because when exposure processing is performed on the separate areas by using the different masks in the division exposure, respectively, a difference in position or size occurs between patterns formed by a plurality of masks respectively due to the occurrence of dimensional variations caused by an exposure device or superposition errors of the masks, etc.

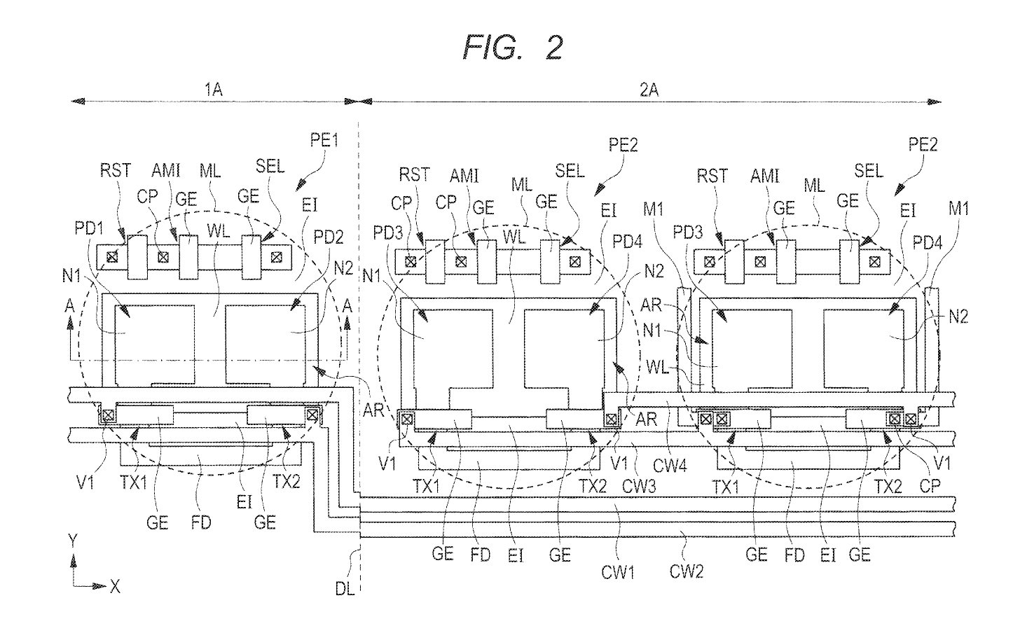

The pixel PE1 has photodiodes (light receiving elements, photoelectric converting parts) PD1 and PD2 each of which generates a signal (electric charge) corresponding to the intensity of irradiated light and has one microlens ML (refer to FIG. 2). The pixel PE2 has photodiodes (light receiving elements, photoelectric converting parts) PD3 and PD4 each of which generates a signal (electric charge) corresponding to the intensity of irradiated light and has one microlens ML (refer to FIG. 2). That is, the pixels PE1 and PE2 respectively have the two photodiodes thereinside.

Control signal wirings CW1 to CW4 for controlling the pixels PE1 and PE2 of the pixel array area PEA are coupled to the control signal generating circuit CS. The control signal wirings CW1 to CW4 pass over the peripheral area SR on the second area 2A side along the Y-axis direction and extend over the pixel array area PEA along the X-axis direction. The control signal wirings CW1 to CW4 extending in the Y-axis direction from the control signal generating circuit CS are formed directly above the peripheral area SR extending along the side of the second area 2A at the end thereof in the X-axis direction, but are not formed directly above other regions in the peripheral area SR. The control signal wirings CW1 to CW4 are respectively branched from directly above the peripheral area SR to over the pixel array area PEA along the X-axis direction and extend in a plural form.

That is, the control signal wirings CW1 to CW4 respectively extend from the outside of the pixel array area PEA to the pixel array area PEA side as seen in the direction in which the first and second areas 1A and 2A of the pixel array area PEA are arranged.

The control signal wirings CW1 and CW2 extending from the control signal generating circuit CS respectively pass over the second area 2A and are coupled to the pixels PE1 of the first area 1A. The control signal wirings CW3 and CW4 extending from the control signal generating circuit CS are respectively coupled to the pixels PE2 of the second area 2A. In order to make it easy to understand the drawing, such an expression that the control signal wirings CW1 and CW2 pass through the lower side of each pixel PE2 in the second area 2A is used herein, whereas any of the control signal wirings CW1 to CW4 is actually formed above the photodiode of each pixel.

Specifically, the control signal wiring CW1 is electrically coupled to a gate electrode which configures a transfer transistor for controlling the transfer of an electric charge generated at the photodiode PD1 in each pixel PE1. The control signal wiring CW2 is electrically coupled to a gate electrode which configures a transfer transistor for controlling the transfer of an electric charge generated at the photodiode PD2 in each PE1. That is, the control signal wirings CW1 and CW2 respectively pass directly above the second area 2A in the pixel array area PEA and are coupled to one of the two photodiodes in each pixel PE1 of the first area 1A. The drawing shows that each control signal wiring is attached with a black circle, and thus the photodiode and the control signal wiring which overlap with the black circle are coupled to each other.

Similarly, the control signal wiring CW3 is electrically coupled to a gate electrode which configures a transfer transistor for controlling the transfer of an electric charge generated at the photodiode PD3 in each pixel PE2. The control signal wiring CW4 is electrically coupled to a gate electrode which configures a transfer transistor for controlling the transfer of an electric charge generated at the photodiode PD4 in each pixel PE2. That is, the control signal wirings CW3 and CW4 are respectively coupled to one of the two photodiodes in each pixel PE2 of the second area 2A in the pixel array area PEA and are not formed directly above the first area 1A.

Here, the control signal generating circuit CS is a circuit which controls a signal to be transmitted to the gate electrode of the transfer transistor formed adjacent to each photodiode. As will be described later, the control signal generating circuit CS may be a circuit which controls a signal to be transmitted to a gate electrode of a selection transistor or a reset transistor which is part of peripheral transistors respectively included in the pixels PE1 or PE2. The control signal generating circuit CS will however be described herein assuming that the control signal generating circuit CS is basically taken as being a circuit for control of the transfer transistor.

A concrete layout of a plurality of pixels and wirings coupled to the pixels will be described below using FIG. 2. FIG. 2 is a plan layout showing, in an enlarged form, part of the solid-state imaging device showing the semiconductor device according to the present embodiment. One pixel PE1 and two pixels PE2 arranged to be aligned with respect to the pixel PE1 with the boundary line DL interposed therebetween are shown herein. Since each of the pixels has substantially the same structure except for the layout of the wires, the configuration of the pixel PE1 will be described below by way of example.

As shown in FIG. 2, the pixel PE1 has one microlens ML and photodiodes PD1 and PD2 lying in a light receiving unit. In the pixel PE1, the one microlens ML and the two photodiodes PD1 and PD2 are respectively arranged so as to overlap with each other in plan view. Incidentally, in the pixel PE2, a microlens ML and two photodiodes PD3 and PD4 are arranged so as to overlap with other. In the drawing, the contour of each microlens ML is indicated by a broken line.

In the pixel PE1, a plurality of peripheral transistors and substrate contact parts (not shown) are arranged around the light receiving unit. The peripheral edges of respective active regions of the light receiving unit, the peripheral transistors, and the substrate contact parts are surrounded by an element isolation region EI. The peripheral transistors mentioned herein respectively indicate a reset transistor RST, an amplifying transistor AMI, and a selection transistor SEL.

The active region AR including the light receiving unit has a shape close to a rectangle in plan view. Each peripheral transistor is formed in the same active region within one pixel PE1. The active region extends in the X-axis direction along one side of the active region AR of the light receiving unit. Although not shown in the drawing, the active region that configures each substrate contact part extends, for example, in the Y-axis direction along the other side of the active region AR of the light receiving unit or is formed, for example, in an island fashion in the neighborhood of the active region AR.

A transfer transistor TX1 with the photodiode PD1 of the active region AR as a source region, and a transfer transistor TX2 with the photodiode PD2 of the active region AR as a source region are formed in the other side of the active region AR or one side located on the side opposite to the side at which each peripheral transistor is formed. That is, within the active region AR, the photodiodes PD1 and PD2 are arranged side by side in the X-axis direction, and the transfer transistors TX1 and TX2 are arranged side by side in the X-axis direction in association with the photodiodes PD1 and PD2.

Each of the peripheral transistors has a gate electrode GE which extends in the Y-axis direction, and each of the transfer transistors TX1 and TX2 has a gate electrode GE which extends in the X-axis direction. The gate electrode GE is comprised of, for example, polysilicon and formed over the semiconductor substrate through a gate insulating film (not shown) interposed therebetween.

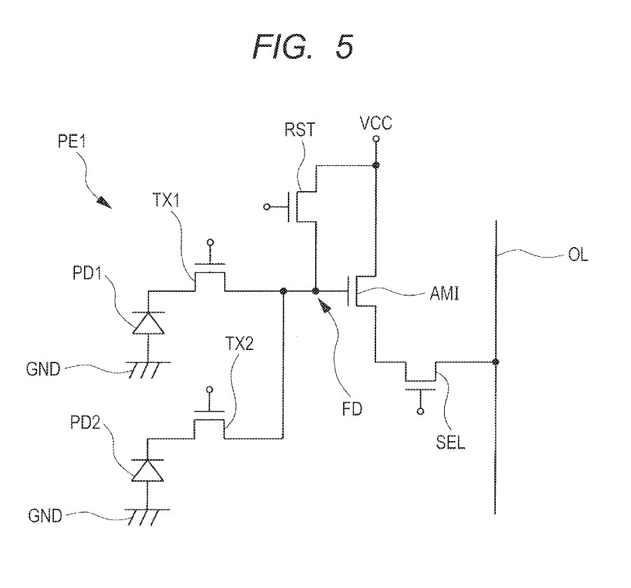

In the active region in which the peripheral transistors are formed, the reset transistor RST, the amplifying transistor AMI, and the selection transistor SEL are arranged in order side by side in the X-axis direction. The reset transistor RST and the amplifying transistor AMI share drain regions with each other. Further, a source region of the reset transistor RST is coupled to drain regions of the transfer transistors TX1 and TX2, i.e., floating diffusions (floating diffusion parts) FD. A source region of the amplifying transistor AMI functions as a drain region of the selection transistor SEL. A source region of the selection transistor SEL is coupled to an output line OL as will be described using FIG. 5.

The drain regions of the transfer transistors TX1 and TX2, the source region of the selection transistor SEL, the source region of the reset transistor RST, and the drain region of the amplifying transistor AMI, which are illustrated in FIG. 2 are respectively N⁺ type semiconductor regions formed in the main surface of the semiconductor substrate. The substrate contact parts (not shown) are P⁺ type semiconductor regions formed in the main surface of the semiconductor substrate. Contact plugs CP are respectively coupled to upper surfaces of their semiconductor regions. Further, although not shown in the drawing, contact plugs are coupled even to upper surfaces of gate electrodes GE of the respective peripheral transistors. Incidentally, the illustration of wirings coupled to the peripheral transistors is omitted herein.

Each of the substrate contact parts (not shown) is a region to which a ground potential GND (refer to FIG. 5) is applied, and has the role of preventing the occurrence of a variation in the threshold voltage of each peripheral transistor by fixing the potential of a well at the upper surface of the semiconductor substrate to 0 V.

The photodiode PD1 and the photodiode PD2 arranged in the X-axis direction within the active region AR corresponding to the light receiving unit are both semiconductor elements extending in the Y-axis direction. That is, the longitudinal directions of the photodiodes PD1 and PD2 extend along the Y-axis direction.

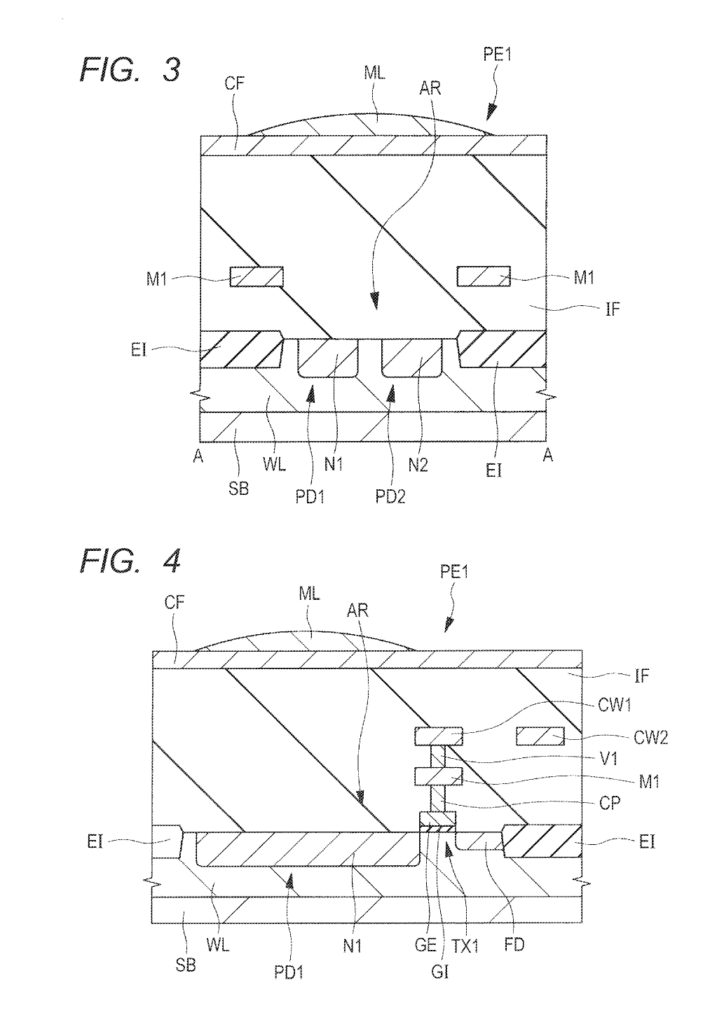

As will be described later using FIGS. 3 and 4, the photodiode PD1 is comprised of an N⁻ type semiconductor region N1 formed in the main surface of the semiconductor substrate, and a well region WL which is a P-type semiconductor region. Likewise, the photodiode PD2 is comprised of an N⁻ type semiconductor region N2 formed in the main surface of the semiconductor substrate, and the well region WL. The photodiodes PD1 and PD2 which are of the light receiving elements shown in FIG. 2 can be assumed to have been formed in regions for forming the N⁻ type semiconductor regions N1 and N2. In the light receiving unit in the active region AR, the P⁻ type well region WL is formed in a region other than the regions in which the N⁻ type semiconductor regions N1 and N2 are formed.

While the active region AR has the shape close to the rectangle in plan view, two projection parts are formed at one of the four sides of the rectangle. The drain region (floating diffusion FD) of the transfer transistor TX1 is formed at one of these projection parts, and the drain region (floating diffusion FD) of the transfer transistor TX2 is formed at the other thereof. Further, the gate electrodes GE are arranged so as to straddle over the two projection parts respectively.

The two projection parts are coupled to each other. That is, the active region AR has an annular layout including a rectangular pattern and two projection patterns which project from one side of the rectangular pattern and are coupled to each other. Thus, the transfer transistors TX1 and TX2 share the floating diffusions FD with each other. An element isolation region EI is formed in the region surrounded by the annularly-formed active region AR in a manner similar to the outside of the active region AR. Incidentally, the two projection parts may not be coupled at the main surface of the semiconductor substrate SB. That is, the active region AR may not have an annular structure. In this case, the floating diffusions FD of the transfer transistors TX1 and TX2 are electrically coupled to each other by the contact plugs and wirings above the semiconductor substrate.

While the structure of the pixel PE1 has been described so far, the pixel PE2 also has a similar structure. That is, the pixel PE2 has photodiodes PD3 and PD4 arranged in the X-axis direction within an active region AR which overlaps with a microlens ML in plan view. Peripheral transistors are formed in the neighborhood of the active region AR.

Here, since the pixel PE1 of the first area 1A and the pixels PE2 of the second area 2A are formed using different masks by division exposure, their mutual positions are shifted in one direction with the boundary line DL as the boundary. Thus, the pixels PE1 and the pixels PE2 are arranged substantially linearly side by side in the X-axis direction in the pixel array area, but strictly shifted in forming position. Thus, although the interval between the two pixels PE1 adjacent to each other, and the interval between the two pixels PE2 adjacent to each other are substantially the same, there is a difference between the above interval and the interval between the pixels PE1 and PE2 adjacent to each other.

Contact plugs CP are coupled to upper surfaces of gate electrodes GE of transfer transistors TX1 and TX2 of the pixel PE2. The contact plugs CP are coupled to a wiring M1 located above the photodiodes PD3 and PD4 and the transfer transistors TX1 and TX2. The wiring M1 configures the lowest first wiring layer of a plurality of wiring layers laminated over the semiconductor substrate.

Here, in order to make it easy to understand the drawing, the wiring M1 is shown herein only in the pixel PE2 on the right side of the drawing, but wirings M1 and contact plugs CP coupling the wirings M1 and gate electrodes GE are formed in all pixels. That is, the wirings M1 are coupled to the gate electrodes GE of the transfer transistors TX1 and TX2 of the pixels PE1 and PE2 one by one. Further, the illustration of contact plugs and wirings coupled to floating diffusions FD is omitted in the drawing.

The wiring M1 coupled to the gate electrode GE of the transfer transistor TX1 extends in the Y-axis direction along the short side of the active region AR of the pixel PE2 from just above the gate electrode GE in plan view. The wiring M1 coupled to the gate electrode GE of the transfer transistor TX2 also similarly extends in the Y-axis direction along the other short side of the active region AR. Further, similarly even in the pixel PE1, the wiring M1 is coupled to each of the gate electrodes GE of the transfer transistors TX1 and TX2. The wiring M1 is a wiring for detecting a signal transmitted to the gate electrode GE of each of the transfer transistors TX1 and TX2.

Further, the wiring M1 (not shown) coupled to the transfer transistor TX1 of the pixel PE1 is coupled to its corresponding control signal wiring CW1 through a via V1 directly above the gate electrode GE of the transfer transistor TX1 of the pixel PE1. Likewise, the wiring M1 (not shown) coupled to the transfer transistor TX2 of the pixel PE1 is coupled to its corresponding control single wiring CW2 through a via V1 directly above the gate electrode GE of the transfer transistor TX2 of the pixel PE1.

Further, the wiring M1 coupled to the transfer transistor TX1 of the pixel PE2 is coupled to its corresponding control signal wiring CW3 through a via V1 directly above the gate electrode GE of the transfer transistor TX1 of the pixel PE2. Likewise, the wiring M1 coupled to the transfer transistor TX2 of the pixel PE2 is coupled to its corresponding signal wiring CW4 through a via V1 directly above the gate electrode GE of the transfer transistor TX2 of the pixel PE2. Incidentally, in FIG. 2, each contact plug CP located below the wiring M1 is shown in a see-through form. Further, the vias V1 located below the control signal wirings CW1 to CW4 are shown in a see-through form.

The control signal wirings CW1 to CW4 configure a second wiring layer located one layer higher than the first wiring layer, of the wiring layers. Each of the control signal wirings CW3 and CW4 is terminated on the pixel PE2 adjacent to the boundary line DL in the X-axis direction and does not extend over the first area 1A.

Thus, in the present embodiment, the separate control signal wirings CW1 to CW4 are respectively electrically coupled to the gate electrodes GE of the transfer transistors TX1 and TX2 respectively adjacent to the photodiodes PD1 to PD4 included in the pixel PE1 of the first area 1A and the pixels PE2 of the second area 2A. That is, the transfer transistor TX1 adjacent to the photodiode PD1, the transfer transistor TX2 adjacent to the photodiode PD2, the transfer transistor TX1 adjacent to the photodiode PD3, and the transfer transistor TX2 adjacent to the photodiode PD4 can respectively independently be controlled.

Incidentally, the N⁻ type semiconductor regions N1 and N2, gate electrodes GE, interlayer insulating film, wiring M1, and control signal wirings CW1 to CW4, etc. are also respectively formed not only by an exposure process in the process of forming the active region AR and the element isolation region EI, but also by a plurality of exposure processes by division exposure. Those exposure processes are all performed on the separate exposure areas separated by the boundary line DL using the different masks.

That is, the division exposure is performed even in any process such as an ion implantation process for forming the N⁻ type semiconductor regions N1 and N2, a process for forming contact holes to embed the contact plugs CP therein, etc. The boundary line DL is defined as the boundary for division even in any division exposure process. As a result, the plan layouts of the N⁻ type semiconductor regions N1 and N2, gate electrodes, contact holes, wirings M1, control signal wirings CW1 to CW4, etc. are formed into shapes shifted in the respective regions which interpose the boundary line DL therebetween.

FIG. 2 shows a structure in which the active region AR, photodiodes PD1 and PD2, and the gate electrodes GE and contact plugs CP located around the active region AR, etc., which configure the pixel PE1 are respectively formed in positions shifted in the same direction with respect to the pixel PE2. Since, however, the active region AR, photodiodes PD1 and PD2, gate electrodes GE and contact plugs CP, etc. are respectively pattern-formed by separate exposure processes using separate masks, their patterns are not limited to be formed with being shifted with the same shift amount in the same direction. That is, the active region, the semiconductor region, the gate electrode and the wirings, etc., which are pattern-formed in different processes can be formed with being shifted in various directions with the vicinity of the boundary line DL as the boundary without being formed shifted in the same direction due to mask's positional shifting.

A sectional diagram taken along line A-A of one pixel PE1, i.e., a sectional diagram along the direction in which photodiodes PD1 and PD2 are arranged is shown in FIG. 3. The illustration of the boundary among a plurality of interlayer insulating films laminated over a semiconductor substrate SB is omitted in the sectional diagram shown in FIG. 3. As shown in FIG. 3, a P⁻ type well region WL is formed within the upper surface of the semiconductor substrate SB comprised of N⁻ type monocrystalline silicon or the like. An element isolation region EI which sections an active region AR and another active region is formed over the well region WL. The element isolation region EI is comprised of, for example, a silicon oxide film and embedded in a trench formed in the upper surface of the semiconductor substrate SB.

N⁻ type semiconductor regions N1 and N2 are formed within the upper surface of the well region WL with being interposed by the element isolation region EI. The well region WL which forms a PN junction with the N⁻ type semiconductor region N1 functions as an anode of the photodiode PD1. The well region WL which forms a PN junction with the N⁻ type semiconductor region N2 functions as an anode of the photodiode PD2. The N⁻ type semiconductor region N1 and the N⁻ type semiconductor region N2 are provided within one active region AR interposed by the element isolation region EI.

Thus, the photodiode PD1 comprised of the N⁻ type semiconductor region N1 and the well region WL, and the photodiode PD2 comprised of the N⁻ type semiconductor region N2 and the well region WL are formed within the active region AR formed in the pixel. The photodiodes PD1 and PD2 are arranged within the active region AR side by side through the region in which the well region WL is exposed over the upper surface of the semiconductor substrate SB. The forming positions of the N⁻ type semiconductor regions N1 and N2 respectively correspond to the forming positions of the photodiodes PD1 and PD2 of FIG. 2. That is, parts where the N⁻ type semiconductor regions N1 and N2 are formed function as photoelectric converting parts.

The formation depth of each of the N⁻ type semiconductor regions N1 and N2 is shallower than that of the well region WL. Further, the depth of the trench at the upper surface of the semiconductor substrate SB, in which the element isolation region EI is embedded, is shallower than the formation depth of each of the N⁻ type semiconductor regions N1 and N2.

An interlayer insulating film IF is formed over the semiconductor substrate SB so as to cover the element isolation region EI and the photodiodes PD1 and PD2. The interlayer insulating film IF is a laminated film in which a plurality of insulating films are laminated. A plurality of wiring layers are laminated within the interlayer insulating film IF. A wiring M1 covered with the interlayer insulating film IF is formed in a first wiring layer as the lowest layer. Control signal wirings CW1 to CW4 (refer to FIG. 2) are formed over the wiring M1 through the interlayer insulating film IF. The wiring M1 and the control signal wirings CW1 to CW4 are wirings principally containing, for example, aluminum (Al). A color filter CF is formed above the interlayer insulating film IF, and a microlens ML is formed over the color filter CF. When operating the solid-state imaging device, the photodiodes PD1 and PD2 are irradiated with light through the microlens ML and the color filter CF.

No wirings are formed directly above the active region AR including the photodiodes PD1 and PD2. This is to prevent light incident from the microlens ML from being shielded with the wiring and prevent the photodiodes PD1 and PD2 corresponding to the light receiving unit of each pixel from being not irradiated with the light. On the contrary, the wiring is disposed in a region other than the active region AR to prevent the occurrence of photoelectric conversion in the active region in which the peripheral transistors and the like are formed.

A sectional diagram of one pixel PE1, i.e., a sectional diagram in the direction orthogonal to the sectional diagram shown in FIG. 3 is illustrated in FIG. 4. The sectional diagram shows a photodiode PD1, a gate electrode GE of a transfer transistor TX1 adjacent to the photodiode PD1, a contact plug CP coupled to the gate electrode GE, a wiring M1, a via V1, and control signal wirings CW1 and CW2.

As shown in FIG. 4, an N⁻ type semiconductor region N1 which configures the photodiode PD1, and a floating diffusion FD corresponding to an N⁻ type semiconductor region are formed apart from each other in the active region AR of the main surface of the semiconductor substrate SB. The gate electrode GE is formed over the main surface of the semiconductor substrate SB between the N⁻ type semiconductor region N1 and the floating diffusion FD through a gate insulating film GI. The N⁻ type semiconductor region N1, the floating diffusion FD, and the gate electrode GE configure the transfer transistor TX1. An interlayer insulating film IF is formed over the main surface of the semiconductor substrate SB so as to cover the transfer transistor TX1 and the photodiode PD1. The wiring M1 lying over the gate electrode GE, and the control signal wirings CW1 and CW2 lying over the wiring M1 are formed within the interlayer insulating film IF.

The gate electrode GE and the wiring M1 located directly thereon are electrically coupled to each other by the contact plug CP embedded in a contact hole which penetrates the interlayer insulating film IF between the wiring M1 and the gate electrode GE. Further, the wiring M1 and the control signal wiring CW1 directly thereon are electrically coupled to each other by the via V1 embedded in a via hole which penetrates the interlayer insulating film IF between the wiring M1 and the control signal wiring CW1. That is, a control signal is transmitted to the gate electrode GE of the transfer transistor TX1 from the control signal wiring CW1 through the via V1, the wiring M1 and the contact plug CP.

The control signal wirings CW1 and CW2 are arranged so as not to shield light irradiated on the photodiode PD1 from above the semiconductor substrate SB and to overlap with the photodiode PD1 in plan view. This is similar also to control signal wirings CW3 and CW4 shown in FIG. 2.

In the solid-state imaging device which is the semiconductor device according to the present embodiment, the two photoelectric converting parts (e.g., photodiodes) are provided within one pixel because it is possible to improve focusing accuracy and speed where, for example, the solid-state imaging device according to the present embodiment is used in a digital camera having an image plane phase difference type automatic focusing system. Such a digital camera is capable of calculating the drive quantity of the lens necessary for focusing from a deviation amount between signals respectively detected by one photodiode in the pixel and another photodiode therein, i.e., a phase difference therebetween and realizing focusing in a short period of time. Thus, since more fine photodiodes can be formed within the solid-state imaging device by providing a plurality of photodiodes in each pixel, it is possible to enhance the accuracy of automatic focusing.

Incidentally, when a photographed image is outputted, signals (electric charges) of the two photodiodes in each pixel are collectively outputted as one signal. Thus, it is possible to obtain an image with image quality equivalent to that of a solid-state imaging device equipped with a plurality of pixels each having only one photodiode.

Further, the present embodiment describes the photodiode in which the P type well region is taken as the anode and the diffusion layer being the N⁻ type semiconductor region is taken as the cathode. The present embodiment is however not limited to it. Even in a solid-state imaging device having photodiodes each comprised of an N type well and a P⁻ type diffusion layer in the N type well, or photodiodes in each of which a diffusion layer of the same conduction type as a pixel well exists in their surfaces, a similar effect can be brought about. Further, the type of solid-state imaging device is not limited to a CMOS image sensor. Even in the case of a CCD (Charge Coupled Device), the above effect can be obtained by realizing a similar structure.

Next, an equivalent circuit diagram of one pixel included in the semiconductor device according to the present embodiment is shown in FIG. 5. Each of the pixels PE1 shown in FIG. 1 has a circuit shown in FIG. 5. Further, each pixel PE2 including the photodiodes PD3 and PD4 shown in FIG. 1 has a circuit similar to the circuit shown in FIG. 5. Although the circuit and operation of one pixel PE1 will be described herein by way of example, the circuit and operation of the pixel PE2 are also similar.

As shown in FIG. 5, the pixel has photodiodes PD1 and PD2 which perform photoelectric conversion, a transfer transistor TX1 which transfers an electric charge generated in the photodiode PD1, and a transfer transistor TX2 which transfers an electric charge generated in the photodiode PD2. Further, the pixel has a floating diffusion (floating diffusion part) FD which accumulates the electric charges transferred from the transfer transistors TX1 and TX2, and an amplifying transistor AMI which amplifies the potential of the floating diffusion FD.

The pixel is further equipped with a selection transistor SEL which selects whether to output the potential amplified by the amplifying transistor AM1 to an output line OL coupled to the read-out circuit, and a reset transistor RST which initializes the potentials of the cathodes of the photodiodes PD1 and PD2 and the floating diffusion FD to a predetermined potential. Each of the transfer transistors TX1 and TX2, the reset transistor RST, the amplifying transistor AMI, and the selection transistor SEL is an N-type MOS transistor, for example.

A ground potential GND which is a power supply potential on the minus side is applied to anodes of the photodiodes PD1 and PD2. The cathodes of the photodiodes PD1 and PD2 are respectively coupled to sources of the transfer transistors TX1 and TX2. The floating diffusion FD is coupled to drains of the transfer transistors TX1 and TX2, a source of the reset transistor RST, and a gate of the amplifying transistor AMI. A power supply potential VCC on the plus side is applied to a drain of the reset transistor RST and a drain of the amplifying transistor AMI. A source of the amplifying transistor AMI is coupled to a drain of the selection transistor SEL. A source of the selection transistor SEL is coupled to the output line OL coupled to the above read-out circuit.

The operation of the pixel will next be described. First, a predetermined potential is applied to the gate electrodes of the transfer transistors TX1 and TX2 and the reset transistor RST to thereby bring both of the transfer transistors TX1 and TX2 and the reset transistor RST into an on state. In doing so, the electric charges remaining in the photodiodes PD1 and PD2, and the electric charge accumulated in the floating diffusion FD flow to the power supply potential VCC on the plus side, so that the electric charges of the photodiodes PD1 and PD2 and the floating diffusion FD are initialized. Thereafter, the reset transistor RST is brought into an off state.

Next, a PN junction between the photodiodes PD1 and PD2 is irradiated with incident light so that photoelectric conversion is generated by the photodiodes PD1 and PD2. As a result, electric charges are generated in the photodiodes PD1 and PD2 respectively. The electric charges are all transferred to the floating diffusion FD by the transfer transistors TX1 and TX2. The floating diffusion FD accumulates the transferred electric charges therein. Consequently, the potential of the floating diffusion FD changes.

Next, when the selection transistor SEL is brought into an on state, the post-change potential of the floating diffusion FD is amplified by the amplifying transistor AMI, followed by being outputted to the output line OL. Then, the read-out circuit reads the potential of the output line OL.

Incidentally, when image plane phase difference type automatic focusing is carried out, the electric charges of the photodiodes PD1 and PD2 are sequentially transferred and read without simultaneously transferring the electric charges to the floating diffusion FD by the transfer transistors TX1 and TX2 to thereby read out the values of the electric charges to the photodiodes PD1 and PD2. When imaging is performed, the electric charges of the photodiodes PD1 and PD2 are simultaneously transferred to the floating diffusion FD. That is, an output related to a still image is calculated by the sum of both outputs of the two photodiodes of each pixel in the active region of the photodiodes.

Incidentally, in FIG. 1, a description has been made about the case where the signals are generated by the transfer-gate control signal generating circuit CS in which the control signal wirings are arranged at the corner on the second area 2A side, of the solid-state imaging device IS, and the signals are inputted in order of the second area 2A and the first area 1A. However, a structure in which the signals are supplied in order from the first area 1A side to the second area 2A side may of course be adopted.

A main feature of the present embodiment resides in that each pixel can be controlled by the drive conditions different in the right and left divided areas, and the photodiodes far from the center of the pixel array area PEA, of the two photodiodes included in the respective pixels are coupled to each other to thereby make it possible to separately control the photodiode group far from the center and the photodiode group near from the center.

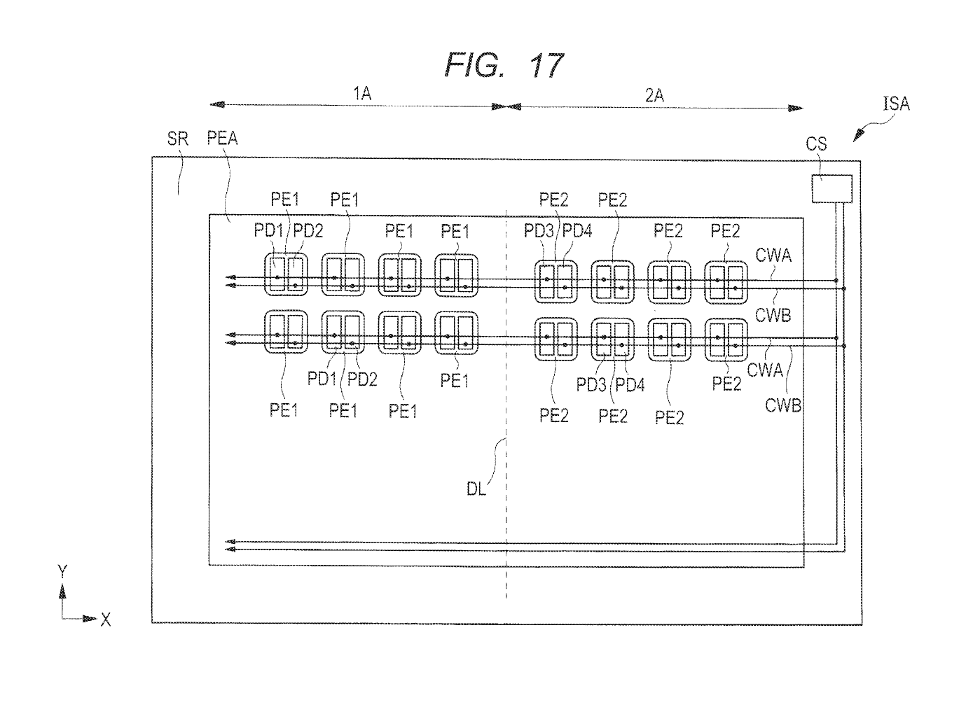

The effect of the semiconductor device according to the present embodiment will hereinafter be described using a comparative example shown in FIG. 17. FIG. 17 is a plan layout showing a solid-state imaging device which is the semiconductor device according to the comparative example.

As shown in FIG. 17, the solid-state imaging device ISA according to the comparative example has the same structure as the solid-state imaging device IS of the present embodiment shown in FIG. 1 except for the wiring layout of control signal wirings. That is, the solid-state imaging device ISA according to the comparative example is formed by division exposure. Pixels PE1 in a first area 1A and pixels PE2 in a second area 2A are formed using separate masks.

Here, control signal wirings CWA and CWB extended from a control signal generating circuit CS are respectively coupled to all of the pixels PE1 and PE2 of one row arranged in an X-axis direction. Specifically, the same control signal wiring CWA is coupled to gate electrodes of transfer transistors adjacent to photodiodes PD1 respectively included in a plurality of pixels PE1 of a prescribed row, and gate electrodes of transfer transistors adjacent to photodiodes PD3 included in a plurality of pixels PE2 of the prescribed row. Further, the same control signal wiring CWB is coupled to gate electrodes of transfer transistors adjacent to photodiodes PD2 respectively included in the pixels PE1 of the prescribed row, and gate electrodes of transfer transistors adjacent to photodiodes PD4 included in the pixels PE2 of the prescribed row.

Further, the control signal wirings CWA and CWB are coupled to all of pixels PE1 and PE2 of plural rows arranged in a Y-axis direction. That is, a control signal transmitted from the control signal wiring CWA is transmitted to all photodiodes PD1 and PD3 in a pixel array area PEA. A control signal transmitted from the control signal wiring CWB is transmitted to all photodiodes PD2 and PD4 in the pixel array area PEA. That is, the comparative example is intended to respectively separately the two photodiodes included in each pixel in an independent manner by using the transfer transistors. However, the comparative example is not intended to separately control the pixels PE1 in the first area 1A and the pixels PE2 in the second area 2A.

Here, a solid-state imaging device which detects light made incident on each of the pixels arranged in an array form through an imaging lens such as a digital camera and thereby performs imaging, involves the following problems. That is, in two photodiodes in each pixel including one microlens, the same imaged outputs are obtained in principle when imaging is performed upon focusing. Since the same outputs are obtained in this way, it is difficult to manufacture the two photodiodes in one pixel with exactly the same position and size.

Further, in a solid-state imaging device in a digital single lens reflex camera or the like, a difference in illuminance between a central part of an image area and its peripheral part, i.e., so-called image abnormality such as shading or the like is apt to occur due to a chip size of the solid-state imaging device being large. That is, the end of the solid-state imaging device is smaller than the central part of the solid-state imaging device in terms of the illuminance of light incident on the solid-state imaging device upon imaging. A cosine fourth law (hereinafter called simply cos⁴ law) is considered as one of the causes leading to the above. The cos⁴ law is a law in which image plane illuminance in an image area, of light made incident on the optical axis of an imaging lens at an angle of θ becomes cos θ̂4 times.

Described specifically, the size of an apparent diaphragm as seen from the object side with respect to light incident on the optical axis of the imaging lens at the angle of θ becomes twice as much as cos θ. Also, the distance of the light from the imaging lens to the image plane becomes 1/cos θ times. The light flux density of the light reaching the image plane when viewed from the surface vertical to the light is proportional to cos θ̂2. Furthermore, since the light is made incident on the image plane at the angle of θ, its illuminance becomes cos θ times. The image plane illuminance becomes cos θ̂4 times by virtue of the synergistic effect of the four properties.

That is, the illuminance of the light applied onto the solid-state imaging device upon imaging becomes smaller as it gets away from the optical axis of the imaging lens. When the chip size is large, this decrease in luminance becomes innegligible. In this case, a problem arises in that image quality is deteriorated because the brightness is degraded in an image obtained by imaging as it goes from the center thereof to its periphery. Further, in the solid-state imaging device which performs the above-described image plane phase difference type automatic focusing and has the two photodiodes in each pixel, a difference occurs between the outputs of the two photodiodes in each pixel due to the cos⁴ law particularly in each pixel close to the end of the pixel array area, thereby causing a problem that focusing becomes delayed.

Incidentally, the problem of degrading the image quality due to the cos⁴ law and the problem of reducing the automatic focusing speed may occur even in either case of the number of the photodiodes in each pixel being one or plural.

Also, in the solid-state imaging device formed by performing division exposure, exposure processing is executed using masks different for every plural exposures. Therefore, pattern transfer is performed on a photoresist film by exposure using a plurality of masks even in lithography in the same process of forming the same kind of patterns in each of first and second exposure areas. As a result, there is a possibility that a difference in interval or size or the like will occur between the patterns formed by the masks respectively due to the occurrence of dimensional variations caused by each mask or an exposure device or the occurrence of overlapping errors. In this case, a problem arises in that a difference in output value occurs between respective pixels in the first and second exposure areas and image abnormality occurs due to the difference.

Further, a difference in output occurs between the two photodiodes in one pixel due to various factors caused by division exposure. Consequently, an error of automatic focusing detection becomes large and the time required for focusing becomes long. If an extra circuit for correcting the output difference is provided to solve such a problem, there occur problems such as a delay in the operation of the solid-state imaging device and an increase in power consumption, etc.

In the solid-state imaging device ISA according to the comparative example shown in FIG. 17, one microlens (not shown) and the two photodiodes PD1 and PD2 are formed with respect to one pixel PE1. This is similar also to the pixel PE2. Coinciding between the amounts of light received by the photodiodes PD1 and PD2 adjacent to each other about the optical axis of the microlens where a light flux emitted from the same object enters the microlens, indicates that a focal point is in focus. On the other hand, a mutual difference between the output values of the photodiodes PD1 and PD2 in one pixel PE1 indicates that the focal point is out of focus, and a focal position is shifted to the upper or lower side with respect to, for example, the surface of the solid-state imaging device.

Now, when the output difference occurs between the photodiodes PD1 and PD2 in each pixel PE1 due to the cos⁴ law as described above, it is not possible to realize accurate imaging and speedy automatic focusing. On the other hand, the following effects can be obtained by separately controlling the photodiodes PD1 and PD2 in the pixel PE1 by using the control signal wirings CWA and CWB as in the solid-state imaging device ISA according to the comparative example. That is, the output values of the two photodiodes PD1 and PD2 at focusing can be made equal to each other by allowing the photodiodes far from the optical axis of the imaging lens to perform photoelectric conversion for a long period of time by, for example, application of signals different in the number of pulses to control lines for the respective transfer gate electrodes of the photodiodes PD1 and PD2, etc.

However, in the solid-state imaging device ISA in which the division exposure is performed to form the pixels PE1 and PE2 in the first area 1A and the second area 2A respectively using the different masks, there is a possibility that an output difference will occur between respective pixels in plural exposure areas due to a dimensional difference between patterns of photodiodes or the like formed in another area by division exposure, etc. In the comparative example, the control signal wiring CWA is coupled to each PE1 of the first area 1A and each PE2 of the second area 2A respectively. The control signal wiring CWB is coupled to each PE1 of the first area 1A and each PE2 of the second area 2A respectively. Thus, it is not possible to prevent the occurrence of the output difference by correcting an accumulating time or the like between the photodiodes PD1 and PD2 in the first area 1A and the photodiodes PD3 and PD4 in the second area 2A.

As a result, since the problem of degrading the image quality of each image obtained by the solid-state imaging device, and the problem of delaying image plane phase difference type automatic focusing arise, the performance of the semiconductor device is degraded.

The semiconductor device according to the present embodiment is formed by the division exposure and has the two photodiodes within each pixel. As shown in FIG. 1 herein, the control signal wiring CW1 is coupled to the photodiode PD1 of the two photodiodes in each pixel PE1 formed in the first area 1A as the first exposure area, and the control signal wiring CW2 is coupled to the photodiode PD2 thereof. Further, the control signal wiring CW3 is coupled to the photodiode PD3 of the two photodiodes in each pixel PE2 formed in the second area 2A as the second exposure area, and the control signal wiring CW4 is coupled to the photodiode PD4 thereof.

In the present embodiment, the time required to accumulate light irradiated on each photodiode is changed by control on the gate of each transfer transistor in the pixel circuit (refer to FIG. 5) of the solid-state imaging device IS to thereby make it possible to adjust (correct) the output of each photodiode. Also, the correction can also be carried out by controlling the accumulation of an electric charge in each photodiode by an adjustment in a reset time for the electric charge of the floating diffusion FD using the reset transistor. Further, the correction can also be performed by controlling reading at each photodiode by an adjustment in a selection period using the selection transistor.

Specifically, it is mentioned that when the correction is performed by the gate control of each transfer transistor in terms of the problem of reducing the output of each photodiode arranged outside away from the center of the pixel array area PEA (image area) due to the cos⁴ law, the correction is performed by the following operation. That is, the output of each photodiode arranged outside is increased by an increase in the number of times of pulses for turning ON the gate electrode of the transfer transistor adjacent to each photodiode lying outside away from the center or prolongation of an ON time for one time of pulse, etc. Using such a drive system enables lowering in the output at the outer periphery of the image area due to the cos⁴ law to be reduced.

Further, when the correction is performed by control on the gate of the reset transistor, the following operation is performed. The value of a voltage applied to the gate of the reset transistor is very important upon setting the magnitude of an initial potential of the floating diffusion FD (refer to FIG. 5). The initial potential of the floating diffusion FD is considered to be set to a value obtained by subtracting the threshold voltage of the reset transistor from the power supply potential. However, here, the initial potential of the floating diffusion FD can be set to values different between the pixels by adjusting the potential applied to the gate of the reset transistor depending on the arrangement position in the pixel array area.

Since the time required for the transfer of the electric charge from the photodiode to the floating diffusion FD changes when the initial potential of the floating diffusion FD varies, it is possible to bring about an effect similar to the case where the number of the pulses at the gate electrode of the transfer transistor is changed as described above.

Further, when the correction is performed by gate control of the selection transistor, the following operation is performed. That is, drain current driving capability of the selection transistor can be changed by changing the gate voltage of the selection transistor of each pixel depending on the arrangement position in the pixel array area. It is thus possible to change a detected output potential. Consequently, it is possible to bring about an effect similar to the case where the number of the pulses at the gate electrode of the transfer transistor is changed as described above.

Accordingly, the control signal wirings CW1 to CW4 may be those which are not limited to the gate control of the transfer transistor as described above, but are used for the gate control of the reset transistor or the selection transistor.

Incidentally, as shown in FIG. 5, a signal is transmitted to each of the gate electrodes of the transfer transistors TX1 and TX2, the reset transistor RST, and the selection transistor SEL from the outside of the pixel PE1. That is, the transfer transistors TX1 and TX2, the reset transistor RST, and the selection transistor SEL can respectively be controlled through the wiring extended from the outside of the pixel PE1. On the other hand, the gate electrode of the amplifying transistor AMI is coupled to the floating diffusion FD. It is not possible to control the amplifying transistor AMI by directly transmitting a control signal from the outside of the pixel PE1 to the gate electrode.

That is, here, the controllable gate electrodes of the gate electrodes of the respective transistors included in the individual pixels are controlled for every photodiode. That is, the present embodiment is intended to respectively independently control the photodiodes PD1 to PD4 included in the pixels PE1 and PE2 shown in FIG. 1. More specifically, it can be said that the gate electrodes of the photodiodes PD1 to PD4 are controlled independently.

Accordingly, in the present embodiment, the photodiodes PD1 and PD2 and the photodiodes PD3 and PD4 in the first area 1A and the second area 2A divided by the boundary line DL for the division exposure can separately be controlled. Thus, the effect of correcting the difference in output between the two photodiodes, which is caused by the cos⁴ law can be obtained by respectively independently controlling the two photodiodes in one pixel. In addition to it, the difference in output between the pixels or photodiodes provided between the two exposure areas due to the division exposure can be corrected.

In other words, with the installation of such control signal wirings CW1 to CW4 as described above, the difference in output between the right and left exposure areas due to the division exposure can be corrected to the same level by control on the accumulation time or the like. Further, the correction of the difference in output between the two photodiodes of each pixel can also be performed.

Thus, it is possible to prevent the peripheral part of an image obtained by the solid-state imaging device from becoming dark due to the difference in output between the pixels or photodiodes. That is, it is possible to enhance the image quality of the image obtained by the solid-state imaging device. Further, it is possible to prevent the image plane phase difference type automatic focusing from being delayed due to the difference in output between the photodiodes. It is thus possible to improve the performance of the semiconductor device.

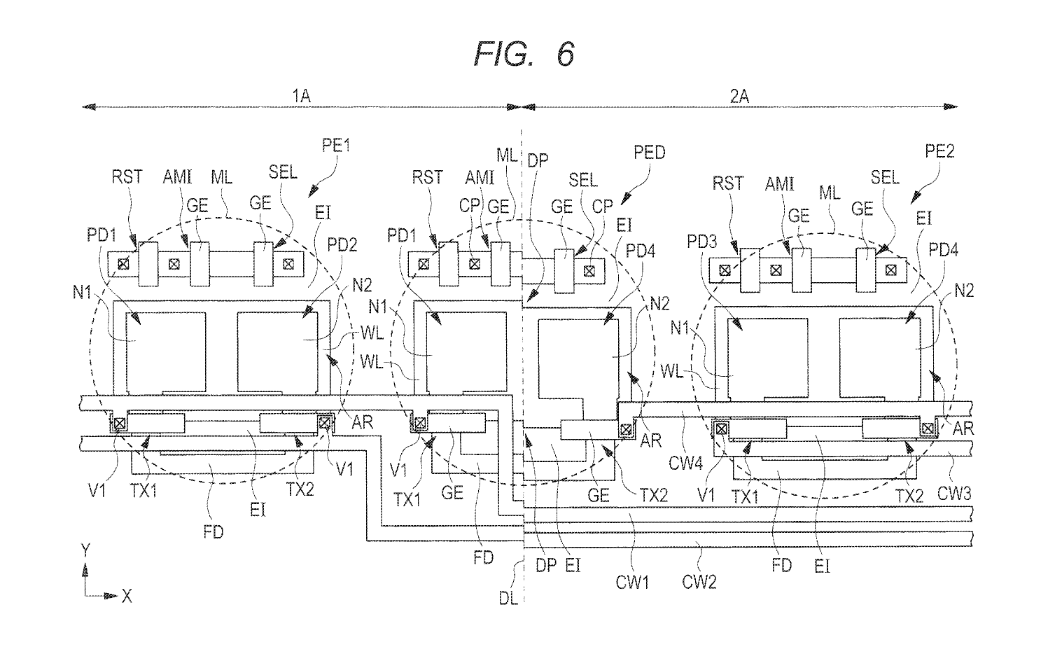

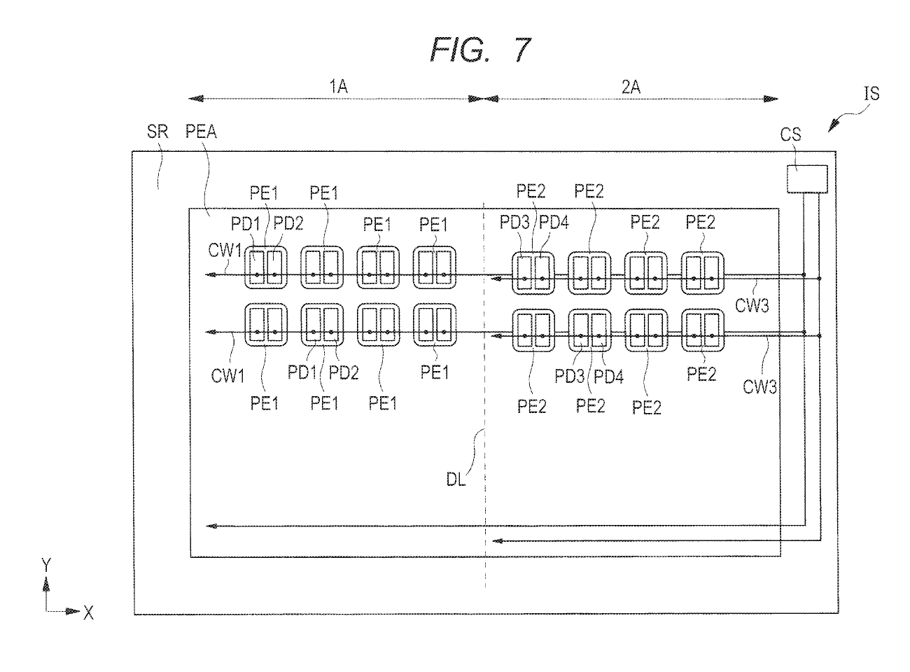

Incidentally, although a description has been made about the case where the boundary line DL for the division exposure is defined between the adjacent pixels PE1 and PE2 in FIGS. 1 and 2, the boundary line DL for the division exposure may be defined in a position where it overlaps with a prescribed pixel PED as shown in FIG. 6. FIG. 6 is a plan layout showing the semiconductor device according to the present embodiment.

In FIG. 6, the boundary line DL is defined between a photodiode PD1 and a photodiode PD4 included in the pixel PED. Thus, a step DP is formed in the central part of the long side of an active area AR in the pixel PED. Further, in an active area AR formed with peripheral transistors of the pixel PED and provided between an amplifying transistor AMI and a selection transistor SEL, a step is formed in a position to overlap with the boundary line DL. Since no contact plug CP is coupled to a main surface of a semiconductor substrate, which configures a drain region between the amplifying transistor AMI and the selection transistor SEL, a connection failure in the contact plug CP does not occur even if the step occurs. The boundary line DL overlaps with all of a plurality of pixels PED arranged in a Y-axis direction in a prescribed column.

With the boundary line DL in the exposure areas for the division exposure existing in the center of the pixel PED, a positional displacement occurs between the photodiode PD1 and the photodiode PD4 in the pixel PED. When imaging is performed using such a solid-state imaging device, a difference in output caused by the division exposure may occur between the photodiode PD1 and the photodiode PD4 in the pixel PED.

In FIG. 6, in order to correct the difference in output, a control signal wiring CW1 is coupled to the photodiode PD1 in a first area 1A, of the photodiodes in the pixel PED, and a control signal wiring CW4 is coupled to the photodiode PD4 in a second area 2A, of the photodiodes in the pixel PED. It is thus possible to correct the output difference caused by the division exposure even between the photodiodes PD1 and PD4 in the pixel PED which overlaps with the boundary line DL.

Incidentally, when the separate control of the photodiodes PD1 and PD4 in the same pixel PED by the control signal wiring CW1 for coupling them to the pixel PE1 in the first area 1A and the control signal wiring CW4 for coupling the same to the pixel PE2 in the second area 2A becomes a problem, for example, the photodiode PD1 in the pixel PED may be controlled by a control signal wiring CW3, and the photodiode PD4 may be controlled by a control signal wiring CW4.

<Regarding Modification 1>

A modification 1 of the present embodiment will hereinafter be described using FIG. 7. FIG. 7 is a plan layout showing a semiconductor device which is the modification 1 of the present embodiment.

The layout of the present modification is different from the layout described using FIG. 1 in that only control signal wirings CW1 and CW3 extend from a control signal generating circuit CS, and the control signal wirings CW1 are coupled to all photodiodes PD1 and PD2 in a first area 1A and the control signal wirings CW3 are coupled to all photodiodes PD3 an PD4 in a second area 2A.

There is considered, for example, a case in which a difference in output due to the cos⁴ law is small between two photodiodes in a pixel. That is, there is considered that when a chip size is relatively small although division exposure is required due to, for example, reasons such as the areas of the two photodiodes being respectively large and the number of pixels being small, a difference in output between the two photodiodes in each pixel is small when comparing a pixel in the center of an image area and its peripheral pixel.

In this case, there is a possibility that when the control signal wirings for individual control on the gate electrodes of both transfer transistors of the respective two photodiodes in the pixels PE1 and PE2 of the first and second areas 1A and 2A are provided as shown in FIG. 1, the aperture ratio of light incidence in the upper portion of each photodiode will be decreased due to the wirings. Therefore, the present modification adopts a structure in which only control lines for correcting the difference in output between the first area 1A and the second area 2A corresponding to the right and left exposure areas are provided.

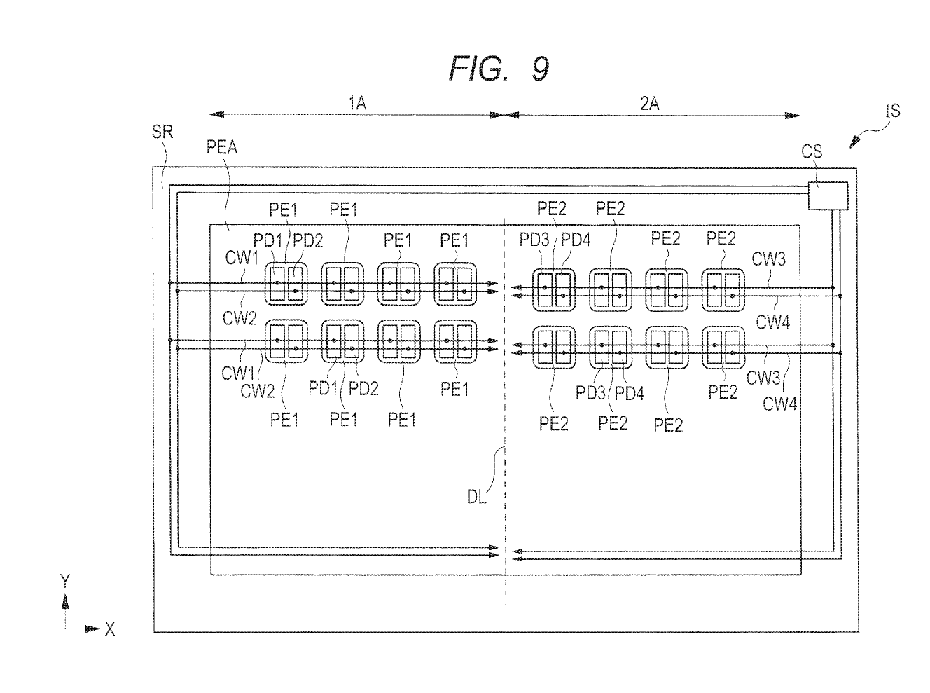

Such a layout reduces the number of wirings and improves light incident efficiency. Further, since power consumption at the driving of the reduced wirings is absent, the effect of a reduction in power consumption is also brought about. Incidentally, the configuration of the present modification can be applied even to a case where control signals are supplied from the right and left of a chip for a solid-state imaging device as in an embodiment 2 to be described later using FIG. 9.

<Regarding Modification 2>

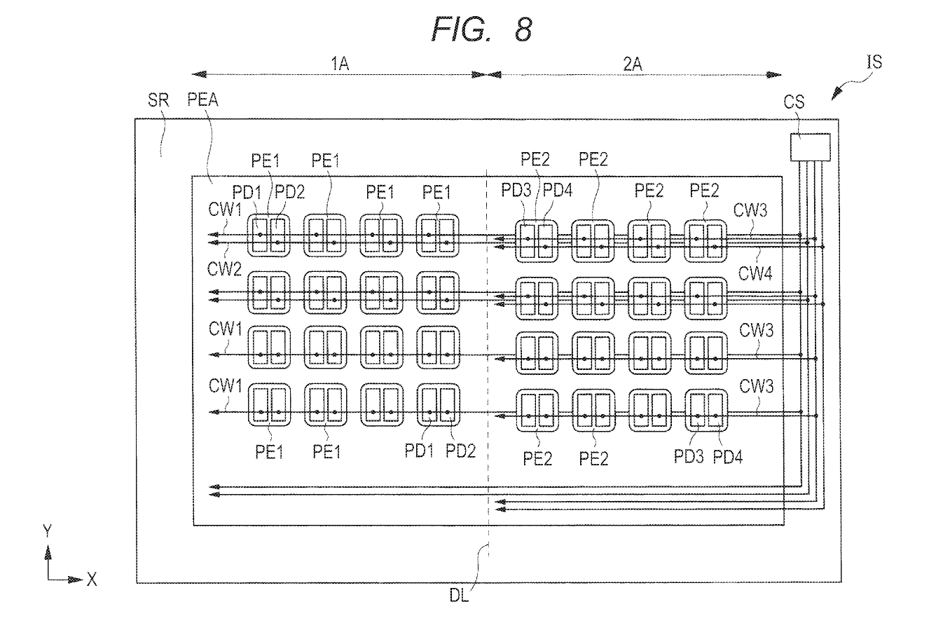

A modification 2 of the present embodiment will hereinafter be described using FIG. 8. FIG. 8 is a plan layout showing a semiconductor device which is the modification 2 of the present embodiment. Although the rows of the pixels arranged in the Y-axis direction are shown only as two in FIG. 1, four rows are shown as the rows of pixels arranged in a Y-axis direction in FIG. 8.

The layout of the present modification is identical to the layout described using FIG. 1 in that the present modification has a structure in which control signal wirings CW1 to CW4 are extended from a control signal generating circuit CS and respectively individually coupled to two photodiodes included in pixels PE1 and PE2. However, although the pixels of the prescribed two rows arranged in the Y-axis direction are identical to the layout of FIG. 1, other pixels arranged in the Y-axis direction with respect to those rows are different from the layout described using FIG. 1 in that only the control signal wiring CW1 or CW3 is coupled.

That is, the pixels at which the two photodiodes of each pixel are respectively controlled by the different control signal wirings, and the pixels at which the two photodiodes of each pixel are respectively controlled by the same control signal wiring are alternately arranged for every two rows in the Y-axis direction.

Specifically, when the pixels of the first, second, third and fourth rows are arranged in order in the Y-axis direction, the control signal wiring CW1 is coupled to a photodiode PD1 and the control signal wiring CW2 is coupled to a photodiode PD2 within each of pixels PE1 of a first area 1A at the first and second rows. On the other hand, one control signal wiring CW1 is coupled to both of photodiodes PD1 and PD2 within each of pixels PE1 of the first area 1A at the third and fourth rows. That is, the wiring layout shown in FIG. 1 is used in the first and second rows, and the wiring layout shown in FIG. 7 is used in the third and fourth rows.

As described above in the above modification 1, there is a case where it is not necessary to realize the accuracy of image plane phase difference type automatic focusing with high accuracy such as where the number of pixels is small and a margin is allowed for an operating speed. In this case, it is possible to, in the entire pixel array area PEA, couple the different signal wirings for every exposure areas and provide the control signal wirings for individually controlling the two photodiodes of each pixel every one or plural rows.

Thus, since the number of control signal wirings can be reduced, it is possible to realize a reduction in power consumption of the entire chip. Also, an improvement in the characteristic such as sensitivity can also be made by improving an aperture rate of each metal wiring directly above each photodiode with a decrease in the number of the metal wirings. Further, since it is possible to correct a difference in output between two photodiodes of each pixel in a prescribed row, deterioration in automatic focusing accuracy can also be suppressed.

Incidentally, the configuration of the present modification can be applied even to the case where the control signals are supplied from the right and left of the chip for the solid-state imaging device as in the embodiment 2 to be described later using FIG. 9.

### Embodiment 2

An embodiment 2 will hereinafter be described using FIG. 9. FIG. 9 is a plan layout showing a semiconductor device according to the present embodiment.

The layout of the present embodiment is the same as the layout described using FIG. 1 in that photodiodes PD1 and PD2 in a first area 1A are individually controlled by using control signal wirings CW1 and CW2, and photodiodes PD3 and PD4 in a second area 2A are individually controlled by using control signal wirings CW3 and CW4. The layout of the present embodiment is however different from the layout described using FIG. 1 in that the control signal wirings CW1 and CW2 do not pass directly above the second area 2A and extend in a pixel array area PEA from the side opposite to the control signal wirings CW3 and CW4 in a solid-state imaging device IS.

That is, in the first area 1A positioned on the left side of a solid-state imaging device IS in FIG. 9, the control signal wirings CW1 and CW2 are extended from the left peripheral area SR of the first area 1A and coupled to pixels PE1. In a second area 2A located on the right side of the solid-state imaging device IS, the control signal wirings CW3 and CW4 are extended from the right peripheral area SR of the second area 2A and coupled to pixels PE2. In this case, the control signal wirings CW1 and CW2 pass over the peripheral area SR of a portion extending along an X-axis direction from a control signal generating circuit CS formed at the right corner of the peripheral area SR, for example and extend from above the peripheral area SR on the left side of the first area 1A to above the first area 1A.

In other words, the control signal wirings CW1 and CW2 extend to the first area 1A from the left end of the solid-state imaging device IS of the drawing, i.e., the peripheral area SR located outside the pixel array area PEA on the first area 1A side in the direction in which the first area 1A and the second area 2A are arranged. Further, the control signal wirings CW3 and CW4 extend to the second area 2A from the right end of the solid-state imaging device IS, i.e., the peripheral area SR located outside the pixel array area PEA on the second area 2A side in the direction in which the first area 1A and the second area 2A are arranged.

That is, the peripheral area SR has a first peripheral area and a second peripheral area. The first peripheral area, the first area 1A, the second area 2A, and the second peripheral area are arranged in order in the X-axis direction. The photodiodes PD1 and PD2 are respectively controlled by signals sent from the control signal wirings CW1 and CW2 extending from the first peripheral area. The photodiodes PD3 and PD4 are respectively controlled by signals sent from the control signal wirings CW3 and CW4 extending from the second peripheral area. The control signal generating circuit CS is within the peripheral area SR located outside the pixel array area PEA including the first area 1A and the second area 2A and is formed on the second peripheral area side.

In the layout in which the control signal wirings CW1 to CW4 are supplied from one side on the right side of the entire chip, the timing provided to operate each pixel greatly differs between each pixel at the right end of the chip and each pixel at the left end thereof. Here, particularly when a variation occurs in the forming dimension of each pixel-in transistor due to division exposure, there occurs a problem that the operating margin of a high-speed operation becomes small. Likewise, when control signals are inputted to pixels of a solid-state imaging device having a large chip size from one side, the operating margin becomes small even in the operation of the image plane phase difference type automatic focusing, thereby causing a problem that it becomes difficult to perform a high-speed focusing detection.

Therefore, the present embodiment has adopted the layout in which the control signal wirings are respectively supplied from both sides of the chip in the X-axis direction in accordance with the division exposure areas (first area 1A and second area 2A) arranged in the X-axis direction. In this case, since the control signals can be supplied simultaneously from the right and left of the chip, the time required for the signals to be supplied to an entire certain row becomes short, thus resulting in enabling the realization of a speed-up of operation. Further, since it is possible to prevent the occurrence of a delay in the transfer of the control signal in one of the first area 1A and the second area 2A, imaging can simultaneously be carried out for the entire chip.

Further, since the illuminance of irradiated light is lowered due to the cos⁴ law as each pixel in the pixel array area PEA is separated from the center of the pixel array area PEA, it is necessary to correct a difference in output between the two photodiodes in each pixel at the end of the pixel array area PEA with accuracy higher than that at each pixel in the central part of the pixel array area PEA.

In the present embodiment, since the control signal wirings can be supplied from the end side of the pixel array area PEA even in both of the first area 1A and the second area 2A, the length of each of the control signal wirings which lead from the peripheral area SR at the end in the X-axis direction of the solid-state imaging device IS to each pixel at the end of the pixel array area PEA in the X-axis direction is short. It is thus possible to perform, with higher accuracy, an adjustment in the difference in output between the two photodiodes in each pixel at the end of the pixel array area PEA in the X-axis direction.

Further, since the control signal wirings CW3 and CW4 for the transfer of the signals to the second area 2A are not arranged over the first area 1A, and the control signal wirings CW1 and CW2 for the transfer of the signals to the first area 1A are not arranged over the second area 2A, the number of the wirings located over each area is reduced, and light incident efficiency is improved.

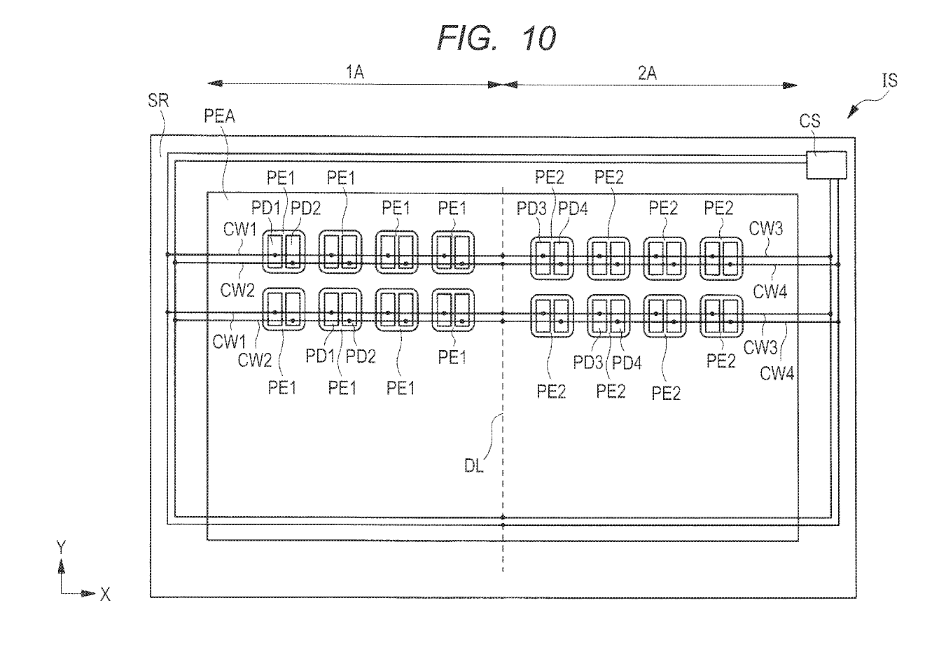

Incidentally, as shown in FIG. 10, the control signal wirings supplied from the right and left may be coupled to each other in the central part of the chip in the X-axis direction, i.e., in the vicinity of the boundary line DL. FIG. 10 is a plan layout of the semiconductor device according to the present embodiment.

Here, the control signal wirings CW1 extending from the left end of the solid-state imaging device IS of the drawing, and the control signal wirings CW3 extending from the right end of the solid-state imaging device IS are coupled to each other in the boundary between the first area 1A and the second area 2A. Further, the control signal wirings CW2 extending from the left end of the solid-state imaging device IS of the drawing, and the control signal wirings CW4 extending from the right end of the solid-state imaging device IS are coupled to each other in the boundary between the first area 1A and the second area 2A.

In this case, each pixel in the vicinity of the central part of the pixel array area PEA is controlled by a control signal reaching the pixel early, of control signals sent from both right and left ends of the solid-state imaging device. Here, it is desirable that the control signals reach from both right and left ends of the solid-state imaging device to the center of the pixel array area PEA with the same timing.

<Regarding Modification 1>

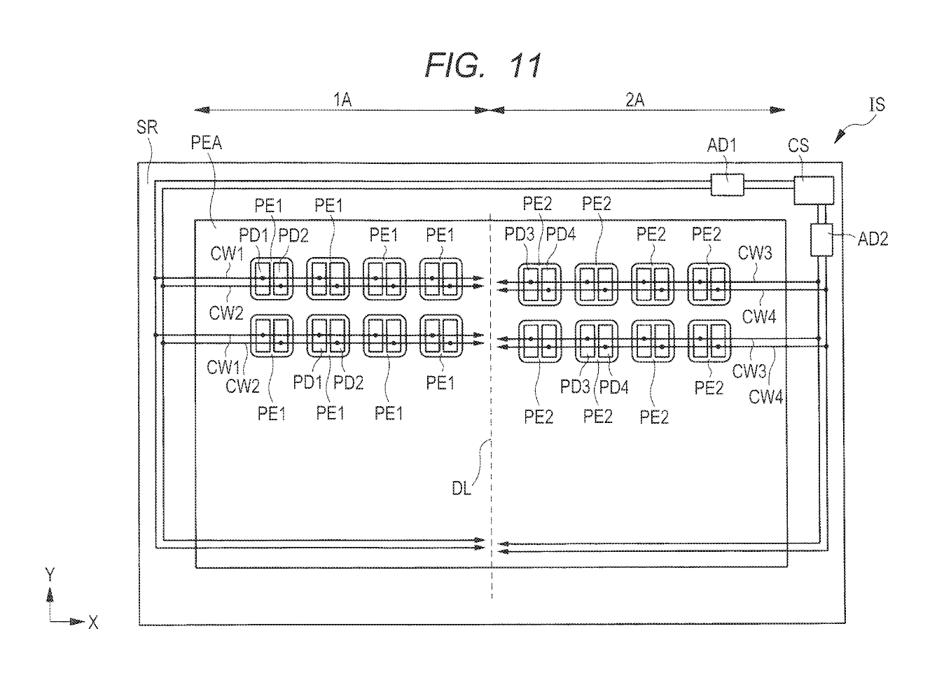

A modification 1 of the present embodiment will be described below using FIG. 11. FIG. 11 is a plan layout showing a semiconductor device which is the modification 1 of the present embodiment.

The layout of the present modification is different from the layout described using FIG. 9 in that a control signal adjustment part AD1 is interposed on the way of control signal wirings CW1 and CW2 extending in a peripheral area SR between a control signal generating circuit CS and a pixel array area PEA, and a control signal adjustment part AD2 is interposed on the way of control signal wirings CW3 and CW4 extending in the peripheral area SR between the control signal generating circuit CS and the pixel array area PEA.

Here, the control signal wirings CW1 to CW4 are supplied from the ends on both right and left sides of the solid-state imaging device to the pixel array area PEA. When the control signal generating circuit CS is disposed on the right side of the solid-state imaging device IS, i.e., in the peripheral area SR at the corner thereof on the second area 2A side, the control signal wirings CW1 and CW2 extending from the control signal generating circuit CS significantly bypass the outside of the pixel array area PEA and are supplied from the left end of the pixel array area PEA.

That is, the lengths of the control signal wirings CW1 and CW2 from the control signal generating circuit CS to the first area 1A are longer than the lengths of the control signal wirings CW3 and CW4 from the control signal generating circuit CS to the second area 2A. In this case, when the control signal wirings CW1 and CW2 supplied from the left side of the pixel array area PEA and the control signal wirings CW3 and CW4 supplied from the right side of the pixel array area PEA are compared with each other, a delay in control signal occurs in the control signal wirings CW1 and CW2.

For this reason, in the present modification, the control signal adjustment parts AD1 and AD2 for adjusting the timings provided to drive the control signals are provided. That is, the control signal adjustment part AD1 has the function of accelerating the control signal, and the control signal adjustment part AD2 has the function of delaying the control signal.

Thus, the control signals supplied from the right end of the solid-state imaging device IS via the control signal wirings CW3 and CW4 are delayed using the control signal adjustment part AD2 to thereby make it possible to align drive timings with the control signals supplied from the left end of the solid-state imaging device IS via the control signal wirings CW1 and CW2. Further, the transfer of the control signals supplied from the left end of the solid-state imaging device IS via the control signal wirings CW1 and CW2 is made faster by using the control signal adjustment part AD1 to thereby make it possible to align drive timings with the control signals supplied from the right end of the solid-state imaging device IS via the control signal wirings CW3 and CW4.

That is, the present modification has the control signal adjustment parts each of which causes a time difference between the time required for the control signal to be transferred from the control signal generating circuit CS to the pixel PE1 and the time required for the control signal to be transferred from the control signal generating circuit CS to the pixel PE2 to be reduced. Incidentally, the above-described adjustment in the drive timing may be performed by providing only either the control signal adjustment part AD1 or AD2.

The means for realizing the above adjustment functions can be realized by various methods. For example, it is considered that when the signal is delayed using the control signal adjustment part AD2, it is counted as the number of clocks by a separately-supplied clock signal to perform its adjustment. Further, it is considered that when it is desired to make early the timing provided to transfer each signal by using the control signal adjustment part AD1, means or the like capable of changing the transistor size of a driving driver in the control signal adjustment part AD1 is built in its circuit.

With the execution of the above adjustments, the respective pixels PE1 and PE2 in the first area 1A and the second area 2A can be controlled with the same timing to perform imaging. Therefore, since an accurate image can be obtained, the performance of the semiconductor device can be improved.

Incidentally, as in the present modification, the configuration of adjusting the drive timings of the respective pixels in the exposure areas by using the control signal adjustment parts can be applied even to the case where the control signals are supplied from one end of the chip for the solid-state imaging device as described using FIGS. 1, 7 and 8. That is, the configuration of performing the adjustment operation in such a manner that the control signal is transferred earlier to each pixel in the exposure area far from the corresponding one end of the chip for the solid-state imaging device, or the configuration of delaying the signal sent to each pixel in the exposure area close from the end, etc. can be applied.

<Regarding Modification 2>

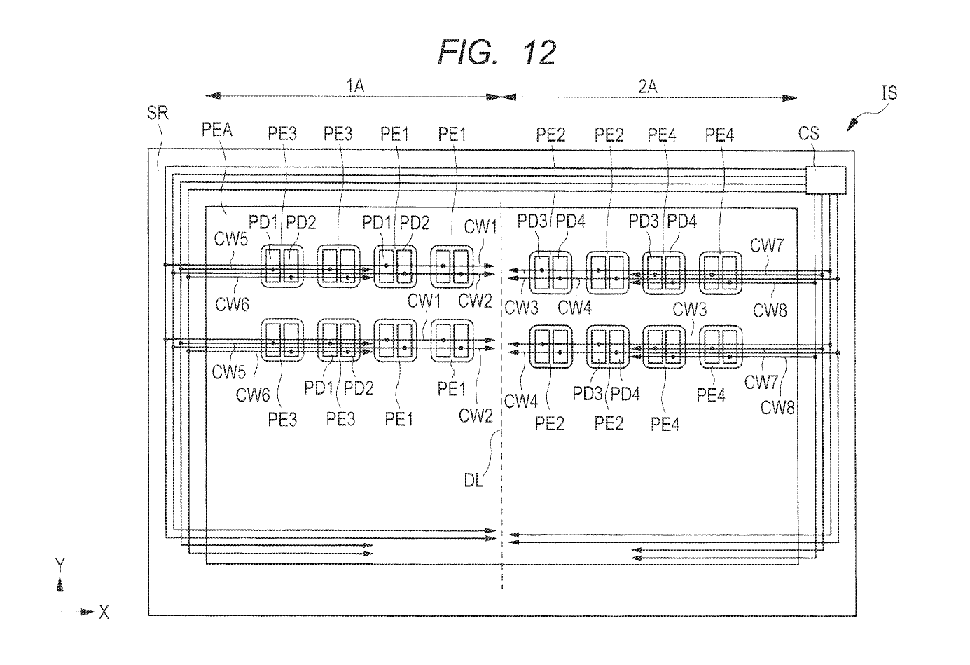

A modification 2 of the present embodiment will be described below using FIG. 12. FIG. 12 is a plan layout showing a semiconductor device which is the modification 2 of the present embodiment.

The layout of the present modification is different from the layout shown in FIG. 9. Pixels PE3 are arranged at an end of a pixel array area PEA in an X-axis direction and an end of a first area 1A. Pixels PE4 are arranged at the other end of the pixel array area PEA in the X-axis direction and an end of a second area 2A. The pixel PE3 in the first area 1A has two photodiodes PD1 and PD2 and has the same structure as each pixel PE1 except for a wiring structure. Further, the pixel PE4 in the second area 2A has two photodiodes PD3 and PD4 and has the same structure as each pixel PE2 except for a wiring structure.

Control signal wirings CW1 are coupled to photodiodes PD1 of the pixels PE1 respectively. Control signal wirings CW2 are coupled to photodiodes PD2 of the pixels PE1 respectively. Control signal wirings CW3 are coupled to photodiodes PD3 of the pixels PE2 respectively. Control signal wirings CW4 are coupled to photodiodes PD4 of the pixels PE2 respectively. This structure is the same as the structure described using FIG. 9. Here, however, the pixels PE3 and PE4, and control signal wirings CW5 to CW8 are further provided.

The pixels PE3 are arranged two side by side from the left end of the pixel array area PEA in the X-axis direction, for example. The pixels PE4 are arranged two side by side from the right end of the pixel array area PEA in the X-axis direction, for example. The pixels PE1 and PE2 are arranged in plural side by side between the pixels PE3 and PE4 in a prescribed row of the pixel array area PEA. That is, in the drawing, the pixels PE1 arranged in the X-axis direction are shown only as two, and the pixels PE2 arranged in the X-axis direction are shown only as two. Actually, however, more pixels PE1 and PE2 are arranged side by side in the X-axis direction.

The control signal wirings CW5 and CW6 extending from a control signal generating circuit CS are supplied to the first area 1A from the left side of a solid-state imaging device IS in a manner similar to the control signal wirings CW1 and CW2. The control signal wirings CW7 and CW8 extending from the control signal generating circuit CS are supplied to the second area 2A from the right side of the solid-state imaging device IS in a manner similar to the control signal wirings CW3 and CW4. The control signal wiring CW5 is coupled to the photodiode PD1 of the pixel PE3, and the control signal wiring CW6 is coupled to the photodiode PD2 of the pixel PE3. Further, the control signal wiring CW7 is coupled to the photodiode PD3 of the pixel PE4, and the control signal wiring CW8 is coupled to the photodiode PD4 of the pixel PE4.

That is, the control signal wirings CW5 toCW8 are wirings for controlling the pixels PE3 and PE4 formed at the right and left ends of the pixel array area PEA and do not extend directly on an area in which the pixels PE1 and PE2 are formed. Further, the control signal wirings CW1 to CW4 are not coupled to the pixels PE3 and PE4. Such a wiring layout brings about an effect as described below where it is desired to perform the driving of each pixel in a certain partial area such as the end of the pixel array area PEA on an operation condition other than at other pixels.

First of all, when the pixels PE3 and PE4 are OB (Optical Black) pixels for detecting the output of each pixel in a state of being not irradiated optically with light, it is possible to separately control the effective pixels PE1 and PE2 used for imaging in the pixel array area PEA, and the pixels PE3 and PE4 being the OB pixels.

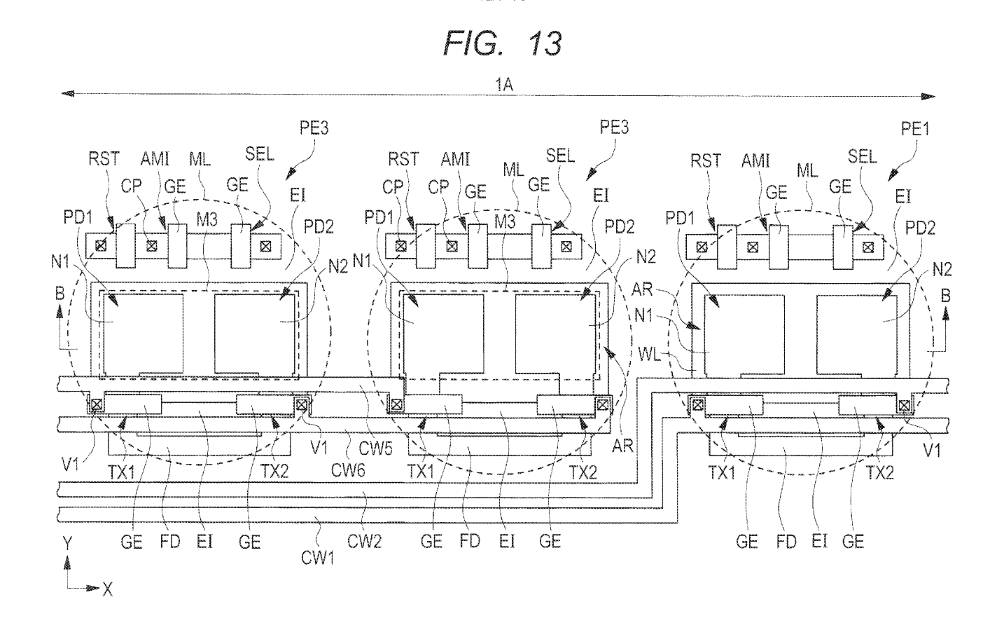

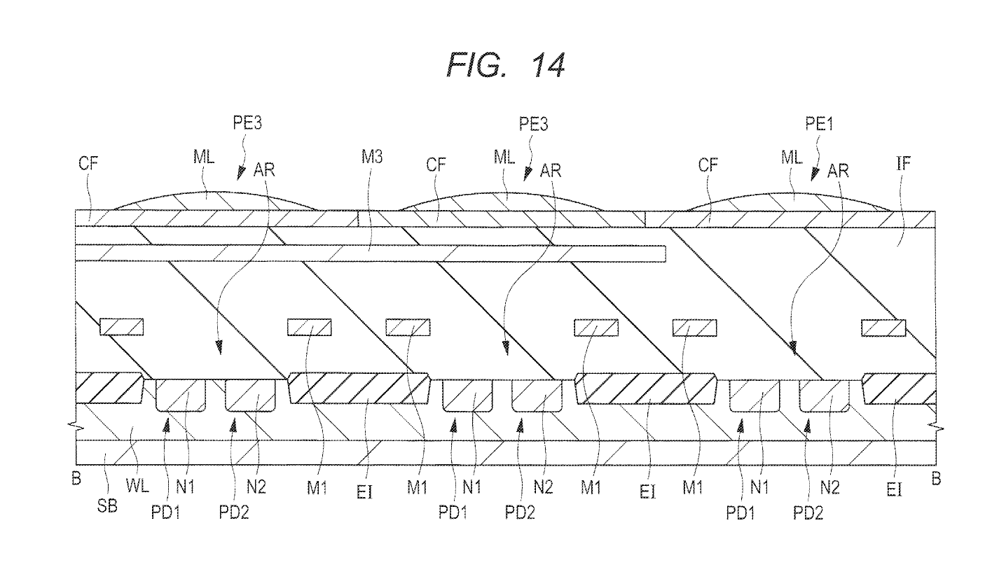

As shown in FIG. 13 and FIG. 14, the pixel PE3 being the OB pixel has a structure in which a wiring (light shielding film) M3 is provided in a third wiring layer between the photodiodes PD1 and PD2 included therein and a microlens ML, so as to shield the upper portions of the photodiodes PD1 and PD2. FIG. 13 is a plan layout showing the pixels PE3 in the present modification and a pixel PE1 adjacent to the corresponding pixel PE3. FIG. 14 is a sectional diagram taken along line B-B of FIG. 13. Although the structure of the pixel PE3 will be described herein, the pixel PE4 (refer to FIG. 12) also has a similar layout. In FIG. 13, the counter of the wiring M3 is indicated by a broken line, and the illustration of contact plugs CP and a wiring M1 coupled to gate electrodes GE of transfer transistors TX1 and TX2 is omitted.

As shown in FIGS. 13 and 14, an area located directly above the photodiodes PD1 and PD2 of the pixel PE3 is covered with the wiring M3 comprised of, for example, an aluminum film. That is, the photodiodes PD1 and PD2 of the pixel PE3 overlap with the wiring M3 in plan view. The wiring M3 is formed above the wiring M1 and the control signal wirings CW1 to CW8. Thus, since light is shielded by the wiring M3 even if imaging is performed using the solid-state imaging device of the present modification, the photodiodes PD1 and PD2 of the pixel PE3 are not irradiated with light. Thus, it is possible for the pixel PE3 to detect an output where the light is not always irradiated.

The OB pixel is a pixel used such as when detecting an output caused by a dark current or the like upon imaging and correcting an image obtained by the imaging. There is a case where it is desirable to operate such a pixel on a condition different from each effective pixel used in imaging and measure an output with higher accuracy. That is, there are, for example, a case where it is desired to read, plural times, OB pixels for detecting a black level as a reference, a case where it is desired to read only OB pixels in a long period of time, etc.

In such a case, as in the present modification, the pixels PE3 and PE4 being the OB pixels shown in FIG. 12 are enabled to be controlled separately from other effective pixels to thereby make it possible to improve the accuracy of reading of the OB pixels.

On the other hand, when the pixels PE3 and PE4 are effective pixels which are not the OB pixels, i.e., when the light shielding wiring M3 is not formed as shown in FIGS. 13 and 14, the following effects are obtained.

That is, secondly, it is also possible to suppress the outputs of the pixels PE1 and PE2 in the central part of the pixel array area PEA, other than the pixels at the end (peripheral portion) of the pixel array area PEA. That is, since the central part of the pixel array area PEA is large in terms of the illuminance of irradiated light, the time required to read the pixels PE1 and PE2 in the central part is made short to reduce an output voltage, thereby making it possible to reduce a difference in output between the pixels at the central part and the end.

Further, since the illuminance of the irradiated light is lowered due to the cos⁴ law as each pixel in the pixel array area PEA is separated from the center of the pixel array area PEA, the difference in output between the pixels in the pixel array area PEA can be reduced by prolongation of readout times of the photodiodes PD1 to PD4 at the pixels PE3 and PE4 of the end of the pixel array area PEA, etc.

Incidentally, the pixels PE3 and PE4 may be arranged not only at the end in the X-axis direction of the pixel array area PEA but also at the end in the Y-axis direction. Further, the configuration of the present modification can be applied even to the case where the control signals are supplied from one end of the chip for the solid-state imaging device as described using FIGS. 1, 7 and 8.

### Embodiment 3

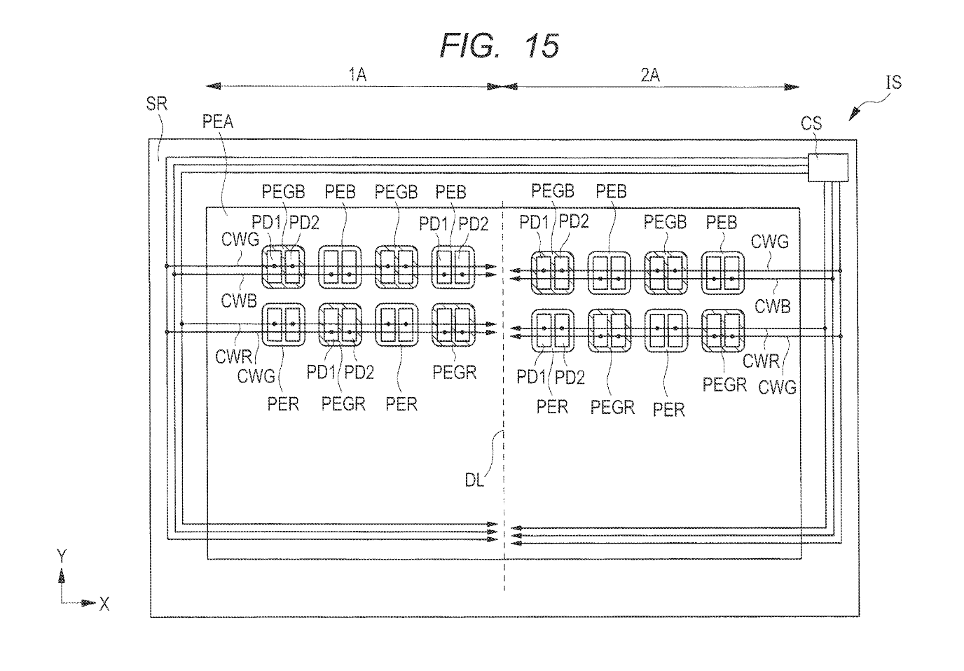

An embodiment 3 will hereinafter be described using FIG. 15. FIG. 15 is a plan layout showing a semiconductor device according to the present embodiment.

Although each pixel in the present embodiment is identical in structure to each pixel described using FIG. 9, the structure of each pixel will be described herein while changing the name and code of each pixel. Also, a description will be made here about a case where control signal wirings CWR, CWG and CWB are extended from a control signal generating circuit CS. The present embodiment relates to a solid-state imaging device in which a plurality of types of pixels are provided to detect different colors, and those pixels are arranged in accordance with the form such as the so-called Bayer array.

As shown in FIG. 15, red pixels PER, green pixels PEGB and PEGR, and blue pixels PEB are respectively arranged in plural numbers in a first area 1A and a second area 2A of a pixel array area PEA. Although the solid-state imaging device IS is formed by performing division exposure with a boundary line DL as the boundary, it will be described in the present embodiment without distinguishing between the codes of the pixels in the first area 1A and the second area 2A. That is, any of the red pixels PER, the green pixels PEGB and PEGR, and the blue pixels PEB in the first area 1A and the second area 2A has photodiodes PD1 and PD2. The green pixels PEGB and PEGR are hatched herein to make it easy to understand the drawing.

The red pixel PER is a pixel for causing a photodiode to detect only red light through a color filter lying over the photodiode. Each of the green pixels PEGB and PEGR is a pixel for causing a photodiode to detect only green light through a color filter. The blue pixel PEB is a pixel for causing a photodiode to detect only blue light through a color filter.

Thus, in the present embodiment, a plurality of kinds of pixels for respectively detecting a plurality of kinds of colors are formed in the pixel array area according to the number of the colors.

Here, as the layout of arrangement of the four pixels of the red pixel PER, the green pixels PEGB and PEGR, and the blue pixel PEB, the Bayer array is adopted in which these four pixels are set as one unit. That is, for example, when four pixels arranged in two rows vertically and in two columns horizontally are defined as one set, the green pixel PEGB and the blue pixel PEB are arranged in the first row in order from the left, and the red pixel PER and the green pixel PEGR are arranged in the second row in order from the left. Further, the green pixels PEGB and PEGR do not adjoin each other even in both of a Y-axis direction and an X-axis direction.

In other words, the pixels for detecting the different colors are alternately arranged in each row and each column. That is, the blue pixels PEB and the green pixels PEGB are alternately arranged in plural in a prescribed row of the pixel array area PEA. The green pixels PEGR and the red pixels PER are alternately arranged in a row adjacent to the prescribed row. Further, the blue pixels PEB and the red pixels PER are alternately arranged in an oblique direction. In other places, the green pixels PEGB and PEGR are alternatively arranged in an oblique direction. In the pixel array area PEA, for example, a unit in which the above four pixels are defined as one unit is repeatedly formed in the X-axis and Y-axis directions.

Here, the control signal wirings CWG and CWB are supplied to the row in which the blue pixels PEB and the green pixels PEGB are arranged in the X-axis direction. Further, the control signal wirings CWR and CWG are supplied to the row in which the green pixels PEGR and the red pixels PER are arranged in the X-axis direction. That is, the control signal wirings CWG are supplied to all rows, whereas the control signal wirings CWR and CWB are alternately supplied to plural rows arranged in the Y-axis direction.

The control signal wiring CWG is couple to both of two photodiodes PD1 and PD2 of each of the green pixels PEGB and PEGR. Also, the control signal wiring CWB is coupled to both of two photodiodes PD1 and PD2 of each of the blue pixels PEB. Further, the control signal wiring CWR is coupled to both of two photodiodes PD1 and PD2 of each of the red pixels PER. That is, such a wiring layout that the two photodiodes included in each pixel are respectively independently controlled is not formed herein.

As compared with the green pixels PEGB and PEGR, the red pixel PER has the characteristics of performing photoelectric conversion in a deep region of a semiconductor substrate at its photodiodes. Further, as compared with the green pixels PEGB and PEGR, the blue pixel PEB has the characteristics of performing photoelectric conversion in a shallow region of the semiconductor substrate at its photodiodes. In terms of such characteristics, the red pixel PER and the blue pixel PEB may be lower in sensitivity than the green pixels PEGB and PEGR. In this case, if the accumulation time at imaging is reduced at each pixel other than the pixels (i.e., either the red pixel PER or the blue pixel PEB, or both of them) low in sensitivity, the outputs of all pixels can be balanced.

Therefore, as in the present embodiment, the different control signal wirings are coupled to the pixels for each color to be detected, thereby making it possible to individually control the accumulation times of the respective photodiodes of the read pixel PER, the blue pixel PEB, and the green pixels PEGB and PEGR. Thus, since each pixel can be operated under the optimum drive condition for each color, the accuracy of correction of image plane phase difference type automatic focusing can be improved. It is therefore possible to improve the performance of the semiconductor device.

Incidentally, the solid-state imaging devices described using FIGS. 1 to 14 may also be provided with pixels different according to a plurality of colors as shown in FIG. 15. That is, each of the solid-state imaging devices described using FIGS. 1 to 14 may have the Bayer array, for example.

<Regarding Modification>

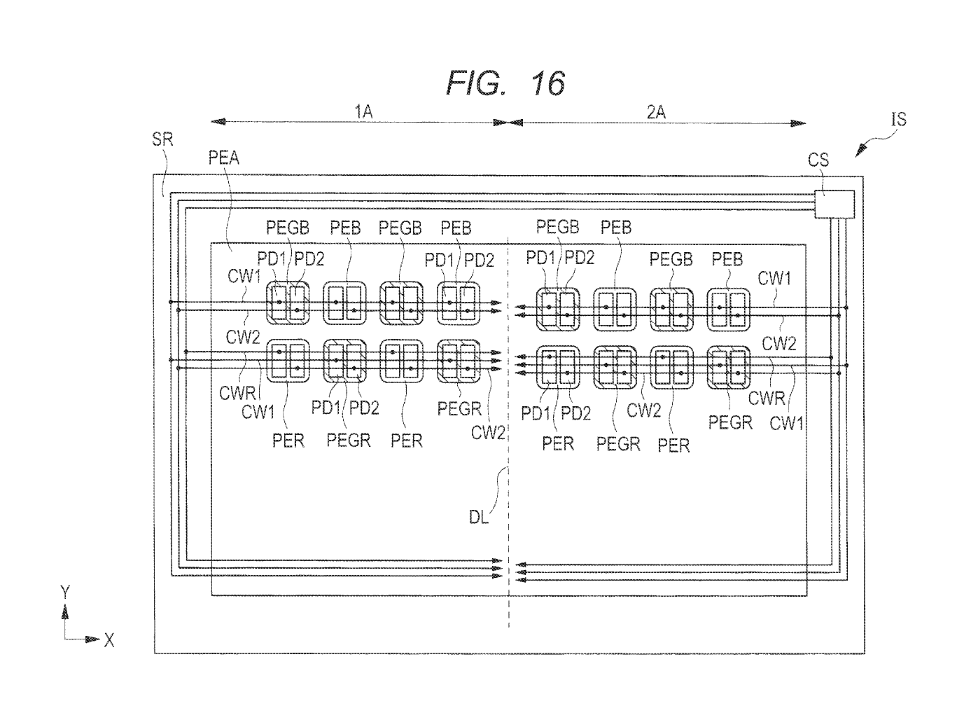

A modification of the present embodiment will hereinafter be described using FIG. 16. FIG. 16 isaplan layout showing a semiconductor device which is the modification of the present embodiment.

The present modification is intended to separately control two photodiodes included in each pixel where pixels different for each color are provided. As shown in FIG. 16, the arrangement of the pixels is similar to the layout shown in FIG. 15. Here, control signal wirings CW1, CW2 and CWR extending from a control signal generating circuit CS are supplied to a first area 1A from the left side of a solid-state imaging device IS. Control signal wirings CW1, CW2 and CWR extending from the control signal generating circuit CS are supplied to a second area 2A from the right side of the solid-state imaging device IS.

The control signal wirings CW1 are coupled to respective photodiodes PD1 of the green pixels PEGB and PEGR and the blue pixels PEB. Further, the control signal wirings CW2 are coupled to respective photodiodes PD2 of the red pixels PER, the green pixels PEGB and PEGR and the blue pixels PEB. The control signal wirings CWR are coupled to respective photodiodes PD1 of the red pixels PER.

That is, the control signal wirings CW2 are coupled to all the pixels, but the control signal wirings CW1 and CWR are coupled to the pixels arranged in each row every other one. Further, the control signal wirings CW1 and CW2 are supplied to all the rows arranged in a Y-axis direction, but the control signal wirings CWR are supplied every other row.

Here, in particular, the red pixel PER is lower in sensitivity than other color pixels in terms of the characteristics of performing photoelectric conversion in a deep region of a semiconductor substrate. Thus, there is a case where it is desirable to reduce the time require to accumulate an electric charge in each pixel other than the red pixel PER and balance respective color outputs. In the present modification, the control signal wiring CWR is coupled to one photodiode PD1 of the two photodiodes included in the red pixel PER to thereby enable only the photodiode PD1 of the red pixel PER to be controlled separately from the photodiode PD2 of the red pixel PER and the photodiodes of other pixels.

Thus, the outputs of all pixels can be balanced by independently controlling only the photodiode PD1 of each red pixel PER and adjusting the time taken for the accumulation of an electric charge, for example. Thus, since it is possible to improve the accuracy of correction of image plane phase difference type automatic focusing, the performance of the semiconductor device can be improved.

Even for other than such a configuration, the photodiodes may independently be controlled only in the blue pixel PEB.

Although the invention made above by the present inventors has been described specifically on the basis of the preferred embodiments, the present invention is not limited to the embodiments referred to above. It is needless to say that various changes can be made thereto within the scope not departing from the gist thereof.

What is claimed is:

1. A semiconductor device comprising:
a solid-state imaging device including:
a semiconductor substrate having a first area and a second area arranged in a first direction at a main surface thereof;
a first pixel which has a first photoelectric converting part and a second photoelectric converting part formed in the main surface of the semiconductor substrate and is formed in the first area; and
a second pixel which has a third photoelectric converting part and a fourth photoelectric converting part formed in the main surface of the semiconductor substrate and is formed in the second area,
wherein the first to fourth photoelectric converting parts are capable of being respectively controlled independently.

2. The semiconductor device according to claim 1, wherein a group of the first pixels formed side by side in plural in a matrix form is formed with being shifted in one direction in plan view with respect to a group of the second pixels formed side by side in plural in a matrix form.

3. The semiconductor device according to claim 1, wherein the first to fourth photoelectric converting parts are respectively controlled independently by controlling signals transmitted to gate electrodes of transistors formed in the first and second pixels respectively.

4. The semiconductor device according to claim 3, wherein the transistors are transfer transistors, reset transistors, or selection transistors.

5. The semiconductor device according to claim 1,
wherein the solid-state imaging device includes a first peripheral area, the first area, the second area, and a second peripheral area arranged in the first direction,
wherein the first photoelectric converting part is controlled by a signal transmitted through a first signal wiring extending from the first peripheral area,
wherein the second photoelectric converting part is controlled by a signal transmitted through a second signal wiring extending from the first peripheral area,
wherein the third photoelectric converting part is controlled by a signal transmitted through a third signal wiring extending from the second peripheral area, and
wherein the fourth photoelectric converting part is controlled by a signal transmitted through a fourth signal wiring extending from the second peripheral area.

6. The semiconductor device according to claim 5,
wherein the solid-state imaging device further has a control signal generation unit which transmits signals to the first to fourth signal wirings, and
wherein the solid-state imaging device further has a signal adjustment unit which reduces a difference between a time taken to transfer a signal from the control signal generating unit to the first pixel and a time taken to transfer a signal from the control signal generating unit to the second pixel.

7. The semiconductor device according to claim 1, further comprising a third pixel provided at an end of a pixel array area including the first area and the second area, with a fifth photoelectric converting part and a sixth photoelectric converting part formed in the main surface of the semiconductor substrate in plan view,
wherein the first to sixth photoelectric converting parts are capable of being respectively controlled independently.

8. The semiconductor device according to claim 7, wherein a light shielding film is formed directly above the fifth photoelectric converting part and the sixth photoelectric converting part.

9. The semiconductor device according to claim 1,
wherein the first pixels and the second pixels are respectively provided with a plurality of kinds of pixels detecting a plurality of kinds of colors respectively according to the number of the colors, and
wherein the first pixels and the second pixels are capable of being controlled independently for each color to be detected.

10. The semiconductor device according to claim 1, further comprising:
a fourth pixel which has two seventh photoelectric converting parts formed in the main surface of the semiconductor substrate and is formed in the first area; and
a fifth pixel which has two eighth photoelectric converting parts formed in the main surface of the semiconductor substrate and is formed in the second area,
wherein the two seventh photoelectric converting parts are capable of being controlled by a signal transmitted from a first signal wiring, and
wherein the two eighth photoelectric converting parts are capable of being controlled by a signal transmitted from a second signal wiring.

11. The semiconductor device according to claim 1, wherein the illuminance of light incident on the main surface of the semiconductor substrate is smaller at an end of the main surface of the semiconductor substrate than at a central part of the main surface thereof at imaging using the solid-state imaging device.

12. A semiconductor device comprising:
a solid-state imaging device including:
a semiconductor substrate having a first area and a second area arranged in a first direction at a main surface thereof;
a first pixel which has two first photoelectric converting parts formed in the main surface of the semiconductor substrate and is formed in the first area; and
a second pixel which has two second photoelectric converting parts formed in the main surface of the semiconductor substrate and is formed in the second area,
wherein the two first photoelectric converting parts are capable of being controlled by a signal transmitted from a first signal wiring,
wherein the two second photoelectric converting parts are capable of being controlled by a signal transmitted from a second signal wiring, and
wherein the two first photoelectric converting parts and the two second photoelectric converting parts are capable of being respectively controlled independently.

13. The semiconductor device according to claim 12, wherein a group of the first pixels formed side by side in plural in a matrix form is formed with being shifted in one direction in plan view with respect to a group of the second pixels formed side by side in plural in a matrix form.

14. The semiconductor device according to claim 12,
wherein the first pixels and the second pixels are respectively provided with a plurality of kinds of pixels detecting a plurality of kinds of colors respectively according to the number of the colors, and
wherein the first pixels and the second pixels are capable of being respectively controlled independently for each color to be detected.
